(19) United States
(12) Patent Application Publication
(10) Pub. No.: US 2026/0089013 A1
(43) Pub. Date: Mar. 26, 2026

(54) Communications System with Remote Security for Host Devices

(71) Applicant: Apple Inc., Cupertino, CA (US)

(72) Inventors: Justin M Hendryx, San Diego, CA (US); Daniel V Chioreanu, Pleasant Hill, CA (US)

(21) Appl. No.: 18/895,136

(22) Filed: Sep. 24, 2024

(51) Int. Cl. H04L 9/32

(52) U.S. Cl. CPC H04L 9/3265; H04L 9/3234; H04L 9/3271

(57) ABSTRACT

A communications system may include a server in a trusted environment and a host device in an untrusted environment. The host device may include storage and a trusted platform module (TPM). The server, a client binary, and the TPM may be used to secure data that is stored at, transmitted by, and/or received by the host device despite the host device being in an untrusted environment. As one example, the server may perform both a challenge-based identity verification and a state verification on the host device prior to transmitting a sensitive data payload to the host device. As another example, the host device may encrypt its storage using a storage key, may discard the storage key, and may interface with the host to provide the storage key to the host device to decrypt the storage after the server has verified the host device.

### FIELD

This relates generally to communications systems, including communications systems that convey data between electronic devices.

### BACKGROUND

Communications systems are used to convey data between electronic devices. The communications system can include wireless links and/or wired links that carry the data between the electronic devices. If care is not taken, a node of the communications system can be susceptible to security threats such as unauthorized access to storage or unauthorized access to data provided to the node by other devices in the communications system.

### SUMMARY

A communications system may include a server in a trusted environment and a host device in an untrusted environment. The host device may communicate with the server over a communications path. The communications path may include one or more wired links, one or more terrestrial-based wireless links, and/or wireless links through a constellation of communications satellites. The host device may include storage and a trusted platform module (TPM) separate from the storage. A client binary may be stored on the storage. The server, the client binary, and the TPM may be used to secure data that is stored at the host device, that is transmitted by the host device to the server, and/or that is received by the host device from the server despite the host device being located in an untrusted environment.

For example, the server may perform both an identity verification and a state verification of the host device prior to transmitting a sensitive data payload to the host device. The identity verification may involve transmission of a challenge request from the client binary to the server. The challenge request may include a public endorsement key stored at the TPM, an endorsement key certificate stored at the TPM, attestation data generated by the TPM, and a public attestation key generated by the TPM based on the public endorsement key. The server may verify the identity of the host device based on this information and may transmit a corresponding challenge to the client binary. The challenge may include an encrypted secret generated by the server based using the endorsement public key, a corresponding credential, and a platform configuration register (PCR) nonce. The client binary may pass information from the challenge to the TPM. The TPM may decrypt the encrypted secret using its endorsement private key and may generate PCR information based on the challenge. The client binary may transmit a request to the server binary that includes the unencrypted secret and the PCR information. The server may complete state and data verification based on the request and may then transmit the data payload to the client binary.

As another example, the host device may generate a storage key that is used to encrypt its storage. The host device may generate a cryptographic fingerprint based on the endorsement certificate stored at the TPM. The host device may transmit the fingerprint to the server. The server may verify the identity of the host device based on the fingerprint, may compare the identity of the host device to a revoked list of host devices, and may generate an exchange key unique to the host device responsive to the identity not being on the revoked list. The server may transmit the exchange key to the host device. The host device may encrypt its storage using the storage key, may encrypt the storage key using the exchange key, and may store the encrypted exchange key on the encrypted storage. When the host device is powered on, the host device may transmit the encrypted storage key to the server. The server may decrypt the encrypted storage key using the exchange key responsive to reverifying the identity of the host device. The server may transmit the decrypted storage key to the host device. The host device may decrypt its storage using the decrypted storage key. The unencrypted storage keys may be discarded instead of being stored.

An aspect of the disclosure provides a method of operating a server. The method can include receiving, via a communications interface with a host device, a challenge request that includes a cryptographic key stored at the host device. The method can include attempting to verify, using processing circuitry, an identity of the host device based on the challenge request. The method can include encrypting, using the processing circuitry, a secret based on the cryptographic key responsive to verifying the identity of the host device. The method can include transmitting, via the communications interface with the host device, a challenge that includes the encrypted secret. The method can include receiving, via the communications interface with the host device, a request that includes the secret. The method can include attempting to verify, using the processing circuitry, a hardware state of the host device based on the request. The method can include transmitting, via the communications interface with the host device, a data payload responsive to verifying the hardware state of the host device.

An aspect of the disclosure provides a method of operating an electronic device. The method can include transmitting, via a communications interface with a server, a challenge request that includes a public endorsement key and an endorsement key certificate stored on a trusted platform module (TPM) in the electronic device. The method can include receiving, via the communications interface with the server, a challenge that includes an encrypted secret generated by the server based on the public endorsement key. The method can include decrypting, at the TPM, the encrypted secret to produce a decrypted secret. The method can include transmitting, via the communications interface with the server, a request for a data payload, wherein the request for the data payload includes the decrypted secret.

An aspect of the disclosure provides a method of operating an electronic device. The method can include generating, using software stored on storage, a cryptographic fingerprint associated with the electronic device based on an endorsement certificate that is stored on a trusted platform module (TPM) separate from the storage. The method can include transmitting, via a communications interface with a server, the cryptographic fingerprint. The method can include receiving, via the communications interface with the server, a first cryptographic key generated by the server based on the cryptographic fingerprint. The method can include encrypting the storage using a second cryptographic key. The method can include encrypting the second cryptographic key using the first cryptographic key. The method can include storing the encrypted second cryptographic key on the encrypted storage

### BRIEF DESCRIPTION OF THE DRAWINGS

FIG. 1 is a diagram of an illustrative communications system including user equipment devices that communicate with gateways via a constellation of communications satellites in accordance with some embodiments.

FIG. 2 is a schematic diagram of an illustrative user equipment device in accordance with some embodiments.

FIG. 3 is a schematic diagram of an illustrative communications satellite in accordance with some embodiments.

FIG. 4 is a schematic diagram of an illustrative network performance monitoring device in accordance with some embodiments.

FIG. 5 is a schematic diagram of an illustrative communications system that includes a server in a trusted environment and a host device in an untrusted environment in accordance with some embodiments.

FIG. 6 is a flow chart of illustrative operations involved in securely conveying data between a server and a host device in accordance with some embodiments.

FIG. 7 is a timing diagram of illustrative operations and signals involved in securely conveying a data payload from a server to a host device in accordance with some embodiments.

FIG. 8 is a flow chart of illustrative operations involved in using a server to remotely encrypt and decrypt storage on a host device in accordance with some embodiments.

FIG. 9 is a diagram showing how an illustrative host device may generate a host device fingerprint for use in verifying the host device at a server in accordance with some embodiments.

FIG. 10 is a diagram showing how an illustrative server may generate an exchange key associated with remotely encrypting and decrypting storage on a host device in accordance with some embodiments.

FIG. 11 is a timing diagram of illustrative operations and signals involved in remotely encrypting storage on a host device in accordance with some embodiments.

FIG. 12 is a timing diagram of illustrative operations and signals involved in remotely decrypting storage on a host device in accordance with some embodiments.

### DETAILED DESCRIPTION

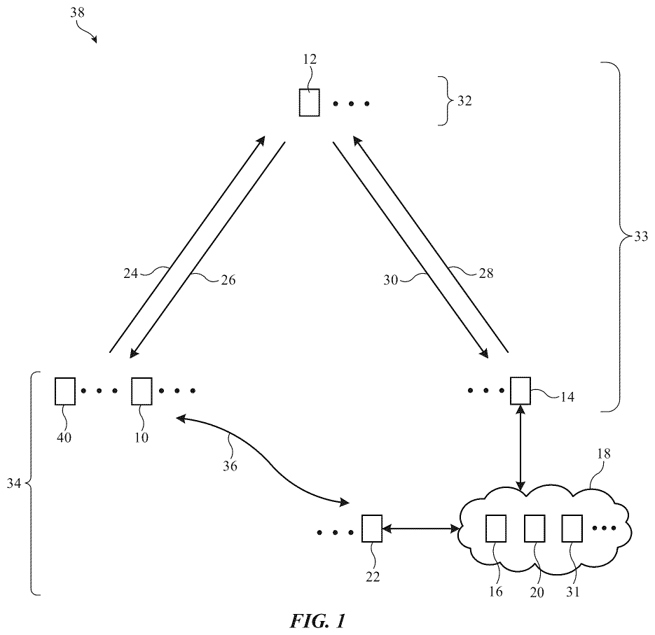

FIG. 1 is a diagram of an illustrative communications system 38. Communications system 38 (sometimes referred to herein as communications network 38, network 38, system 38, satellite communications system 38, or satellite communications network 38) may include a ground-based (terrestrial) gateway system that includes one or more gateways 14 and may include one or more user equipment (UE) devices 10. Gateways 14 and UE devices 10 may form a part of a terrestrial network 34 on Earth. Terrestrial network 34 may include terrestrial-based wireless communications equipment 22 and network portion 18. Terrestrial-based wireless communications equipment 22 may include, for example, one or more wireless base stations (e.g., for implementing a cellular telephone network), wireless access points (e.g., for implementing a wireless local area network (WLAN)), and/or other UE devices (e.g., for implementing a device-to-device (D2D) network, a wireless personal area network (WPAN), etc.).

Communications system 38 may include a constellation 32 of one or more communications satellites 12. UE devices 10, gateways 14, and constellation 32 may form a part of non-terrestrial network (NTN) 33, which conveys signals between UE devices 10 and gateways 14 via constellation 32. Constellation 32 is sometimes also referred to herein as satellite constellation 32. Communications satellites 12 are located in space (e.g., in orbit around Earth). Communications system 38 may include any desired number of gateways 14, any desired number of communications satellites 12, and any desired number of UE devices 10. Only a single gateway 14, a single communications satellite 12, and a single UE device 10 are illustrated in FIG. 1 for the sake of simplicity. Each gateway 14 in communications system 38 may be located at a different respective geographic location on Earth (e.g., across different regions, cities, counties, prefectures, districts, municipalities, land masses, areas, localities, states, provinces, countries, continents, etc.).

Network portion 18 (sometimes also referred to herein simply as network 18) may be communicatively coupled to terrestrial-based wireless communications equipment 22 and each of the gateways 14 in communications system 38. Gateway (GW) 14 may include a satellite network ground station and may therefore sometimes also be referred to as ground station (GS) 14 or satellite network ground station 14. Each gateway 14 may include one or more electronic devices such as servers that interface between constellation 32 and network portion 18. Each gateway 14 may also include wireless equipment communicatively coupled to the device(s). The wireless equipment may include antennas (e.g., electronically and/or mechanically adjustable antennas), modems, transceivers, amplifiers, beam forming circuitry, control circuitry (e.g., one or more processors, storage circuitry, etc.), and other components that are used to convey communications data. The components of each gateway 14 may, for example, be disposed at a respective geographic location (e.g., within the same computer, server, data center, building, etc.). Gateways 14 may convey communications data between terrestrial network 34 and UE devices 10 via satellite constellation 32.

Network portion 18 may include any desired number of network nodes (e.g., terminals, devices, end hosts, etc.) that are communicatively coupled together using communications paths that include wired and/or wireless links. The wired links may include cables (e.g., ethernet cables, optical fibers or other optical cables that convey signals using light, telephone cables, etc.). Network portion 18 may include one or more relay networks, mesh networks, local area networks (LANs), wireless local area networks (WLANs), ring networks (e.g., optical rings), cloud networks, virtual/logical networks, the Internet, combinations of these, and/or any other desired network nodes coupled together using any desired network topologies (e.g., on Earth). The network nodes, terminals, and/or end hosts may include network switches, network routers, optical add-drop multiplexers, other multiplexers, repeaters, modems, servers, network cards, wireless access points, wireless base stations, UE devices such as UE devices 10, and/or any other desired network components. The network nodes in network portion 18 may include physical components such as electronic devices, servers, computers, user equipment, etc., and/or may include virtual components that are logically defined in software and that are distributed across (over) two or more underlying physical devices (e.g., in a cloud network configuration).

Network portion 18 may include one or more satellite network operations centers such as network operations center (NOC) 16. NOC 16 may control the operation of gateways 14 in communicating with satellite constellation 32. NOC 16 may also control the operation of the satellites in satellite constellation 32. For example, NOC 16 may convey control commands via gateways 14 that control positioning operations (e.g., orbit adjustments), sensing operations (e.g., thermal information gathered using one or more thermal sensors), and/or any other desired operations performed in space by satellites 12. NOC 16, gateways 14, and satellite constellation 32 may be operated or managed by a corresponding satellite constellation operator.

Communications system 38 may also include a satellite communications (satcom) network service provider (e.g., a satcom network carrier or operator) for controlling wireless communications between UE devices 10 and terrestrial network 34 via satellite constellation 32. The satcom network service provider may be a different entity than the satellite constellation operator that controls/operates NOC 16, gateways 14, and satellite constellation 32, or may be the same entity as the satellite constellation operator. Terrestrial-based wireless communications equipment 22 in terrestrial network 34 may be operated by one or more terrestrial network carriers or service providers. The terrestrial network carriers or service providers may be different entities than the satcom network service provider or, if desired, may be the same entity as the satcom network service provider.

One or more gateways 14 may control the operations of satellite constellation 32 over corresponding radio-frequency communications links. Satellite constellation 32 may include any desired number of satellites (e.g., two satellites, four satellites, ten satellites, dozens of satellites, hundreds of satellites, thousands of satellites, etc.), one of which is shown in FIG. 1. If desired, two or more of the satellites in satellite constellation 32 may convey radio-frequency signals between each other using satellite-to-satellite (e.g., relay) links.

Constellation 32 may include a set of non-geostationary orbit (NGSO) satellites 12 (e.g., satellites in non-geostationary orbits) and, if desired, may include a set of geostationary orbit (GSO) satellites 12 (e.g., satellites in geostationary/geosynchronous orbits, sometimes referred to as geosynchronous satellites or GEO satellites). GSO satellites in constellation 32 may orbit Earth at orbital altitudes of greater than around 30,000 km. NGSO satellites in constellation 32 may include low earth orbit (LEO) satellites at orbital altitudes of less than around 8,000 km (e.g., satellites in low earth orbits, inclined low earth orbits, low earth circular orbits, etc.), medium earth orbit (MEO) satellites at orbital altitudes between around 8,000 km and 30,000 km (e.g., satellite in medium earth orbits), sun synchronous satellites (e.g., satellites in sun synchronous orbits), satellites in tundra orbits, satellites in Molniya orbits, satellites in polar orbits, and/or satellites in any other desired non-geosynchronous orbits around Earth. If desired, satellites 12 may include multiple sets of satellites each in a different type of orbit and/or each at a different orbital altitude. In general, constellation 32 may include satellites in any desired combination of orbits or orbit types.

The satellites 12 in constellation 32 may communicate with one or more UE devices 10 on Earth using one or more radio-frequency communications links (e.g., satellite-to-user equipment links). Satellites 12 may also communicate with gateways 14 on Earth using radio-frequency communications links (e.g., satellite-to-gateway links). Radio-frequency signals may be conveyed between UE devices 10 and satellites 12 and between satellites 12 and gateways 14 in IEEE bands such as the IEEE C band (4-8 GHz), S band (2-4 GHz), L band (1-2 GHz), X band (8-12 GHz), W band (75-110 GHz), V band (40-75 GHz), K band (18-27 GHz), Kₐ band (26.5-40 GHz), Kᵤ band (12-18 GHz), and/or any other desired satellite communications (satcom) bands. If desired, different bands may be used for the satellite-to-user equipment links than for the satellite-to-gateway links.

Communications may be performed between gateways 14 and UE devices 10 in a forward (FWD) link direction and/or in a reverse (REV or RWD) link direction. In the forward link direction (sometimes referred to simply as the forward link), wireless data is conveyed from gateways 14 to UE device(s) 10 via constellation 32. Wireless data conveyed over the forward link is sometimes referred to herein as forward link data. Forward link data may be organized into a set, series, or stream of forward link datagrams (e.g., having header fields that contain header information, payload fields that contain a forward link data payload, etc.). A gateway 14 may, for example, transmit forward link data to one of the satellites 12 in satellite constellation 32 (e.g., where forward link datagrams are modulated onto one or more carriers of radio-frequency signals 28). Satellite 12 may transmit (e.g., relay, in a bent-pipe configuration) the forward link data received from gateway 14 to UE device(s) 10 (e.g., using radio-frequency signals 26). Radio-frequency signals 28 are conveyed in an uplink direction from gateway 14 to satellite 12 and are therefore sometimes also referred to herein as uplink (UL) signals 28, forward link UL signals 28, or forward link signals 28. Radio-frequency signals 26 are conveyed in a downlink direction from satellite 12 to UE device(s) 10 and are therefore sometimes also referred to herein as downlink (DL) signals 26, forward link DL signals 26, or forward link signals 26.

In the reverse link direction (sometimes referred to simply as the reverse link), wireless data is conveyed from UE device(s) 10 to gateways 14 via satellite constellation 32. Wireless data conveyed over the reverse link is sometimes referred to herein as reverse link data. Reverse link data may be organized into a set, series, or stream of reverse link datagrams (e.g., having header fields that contain header information, payload fields that contain a reverse link data payload, etc.). One of UE devices 10 may, for example, transmit reverse link data to one of the satellites 12 in constellation 32 (e.g., where reverse link datagrams are modulated onto one or more carriers of radio-frequency signals 24). Satellite 12 may transmit (e.g., relay, in a bent-pipe configuration) the reverse link data received from UE device 10 to a corresponding gateway 14 using radio-frequency signals 30. Radio-frequency signals 24 are conveyed in an uplink direction from UE device 10 to satellite 12 and are therefore sometimes also referred to herein as uplink (UL) signals 24, reverse link UL signals 24, or reverse link signals 24. Radio-frequency signals 30 are conveyed in a downlink direction from satellite 12 to gateway 14 and are therefore sometimes also referred to herein as downlink (DL) signals 30, reverse link DL signals 30, or reverse link signals 30. Gateway 14 may forward wireless data between UE device(s) 10 and network portion 18. Network portion 18 may forward the wireless data to any desired network nodes or terminals of terrestrial network 34.

If desired, UE devices 10 may also convey radio-frequency signals with terrestrial-based wireless communications equipment 22 over terrestrial network wireless communication links 36 when available. UE devices 10 may sometimes be referred to herein as being “online” or “on-grid” when the UE devices are within range of terrestrial-based wireless communications equipment 22 and when terrestrial-based wireless communications equipment 22 provides access (e.g., communications resources) to network portion 18 for the UE devices. When the UE devices are online, the UE devices may communicate with other network nodes or terminals in network portion 18 via terrestrial network wireless communications links 36. Conversely, UE devices 10 may sometimes be referred to herein as being “offline” or “off-grid” when the UE devices are out of range of terrestrial-based wireless communications equipment 22 or when terrestrial-based wireless communications equipment 22 does not provide access to network portion 18 for the UE devices (e.g., when terrestrial-based wireless communications equipment 22 is disabled due to a power outage, natural disaster, traffic surge, or emergency, when terrestrial-based wireless communications equipment 22 denies access to network portion 18 for the UE devices, when terrestrial-based wireless communications equipment 22 is overloaded with traffic, etc.).

If desired, UE devices 10 may include separate antennas for handling communications over the satellite-to-user equipment link and one or more terrestrial network wireless communication links 36 or UE devices 10 may include a single antenna that handles both the satellite-to-user equipment link and the terrestrial network wireless communications links. The terrestrial network wireless communications links may be, for example, cellular telephone links (e.g., links maintained using a cellular telephone communications protocol such as a 4G Long Term Evolution (LTE) protocol, a 3G protocol, a 3GPP Fifth Generation (5G) New Radio (NR) protocol, etc.), wireless local area network links (e.g., Wi-Fi® links), wireless personal area network links (e.g., Bluetooth links), D2D links, etc.

The wireless data conveyed in DL signals 26 is sometimes also referred to herein as DL data, forward link DL data, or forward link data. UL signals 28 may also convey the forward link data (e.g., forward link data that is routed by satellite 12 to UE device(s) 10 in DL signals 26). The wireless data conveyed in UL signals 24 is sometimes also referred to herein as UL data, reverse link UL data, or reverse link data. The reverse link data may be generated and transmitted by UE device(s) 10. DL signals 30 may also convey the reverse link data. Forward link data may be generated by any desired network nodes or terminals of terrestrial network 34. Forward link data and the reverse link data may include text data such as email messages, text messages, web browser data, an emergency or SOS message, a location message identifying the location of UE device(s) 10, or other text-based data, audio data such as voice data (e.g., for a bi-directional satellite voice call) or other audio data (e.g., streaming satellite radio data), video data (e.g., for a bi-directional satellite video call or to stream video data transmitted by gateway 14 at UE device(s) 10), cloud network synchronization data, data generated or used by software applications running on UE device(s) 10 (e.g., application data), data for use in a distributed processing network, and/or any other desired data. UE devices 10 may only receive forward link data, may only transmit reverse link data, or may both transmit reverse link data and receive forward link data. Each satellite 12 may communicate with the UE devices 10 located within its coverage area at any given time (e.g., UE devices 10 located within cells on Earth that overlap the signal beam(s) producible by the satellite).

The satcom network service provider for communications system 38 may operate, control, and/or manage a satcom control network such as core network (CN) 20 in network portion 18. CN 20 may sometimes also be referred to herein as satcom network region 20, CN region 20, satcom controller 20, satcom network 20, or satcom service provider equipment 20. CN 20 may be implemented on one or more network nodes and/or terminals of network portion 18 (e.g., one or more servers or other end hosts). In some implementations, CN 20 may be formed from a cloud computing network distributed over multiple underlying physical network nodes and/or terminals distributed across one or more geographic regions. CN 20 may therefore sometimes also be referred to herein as a CN cloud region or satcom network cloud region.

CN 20 may control and coordinate wireless communications between terminals (e.g., end hosts) of terrestrial network 34 and UE devices 10 via satellite constellation 32. For example, gateways 14 may receive reverse link data from UE devices 10 via satellite constellation 32 and may route the reverse link data to CN 20. CN 20 may perform any desired processing operations on the reverse link data. For example, CN 20 may identify destinations for the reverse link data and may forward the reverse link data to the identified destinations. CN 20 may also receive forward link data for transmission to UE devices 10 from one or more terminals or end hosts of terrestrial network 34 (e.g., network portion 18). CN 20 may process the forward link data to schedule the forward link data for transmission to UE devices 10 via satellite constellation 32. CN 20 may schedule the forward link data for transmission to UE devices 10 by generating forward link traffic grants for each of the UE devices that are to receive forward link data. CN 20 may provide the forward link data and the forward link traffic grants to gateways 14. Gateways 14 may transmit the forward link data to UE devices 10 via satellite constellation 32 according to the forward link traffic grants (e.g., according to a forward link communications schedule that implements the forward link traffic grants).

Network portion 18 may include one or more networks 31 that provide wireless data and/or services to UE device 10. Network 31 may include one or more servers. Network 31 may include, for example, a content delivery network (CDN) that provides content to CN 20 for delivery to UE device 10 (e.g., via terrestrial-based wireless communications equipment 22 while UE device 10 is on grid or via constellation 32 while UE device 10 is off grid). If desired, network 31 may receive wireless data from UE device 10 via CN 20 (e.g., via terrestrial-based wireless communications equipment 22 while UE device 10 is on grid or via constellation 32 while UE device 10 is off grid). Network 31 may be the intended recipient of the wireless data or may forward the wireless data to an intended recipient (e.g., another server or network, another UE device, etc.). If desired, network 31 may include a network associated with one or more software applications running on UE device 10.

In practice, the network performance of communications system 38 in conveying wireless data between UE device(s) 10 and gateway(s) 14 may vary over time. This variation can be due to variations in the performance of one or more components on UE device(s) 10, satellite constellation 32, and/or gateway(s) 14, as well as changes in the radio-frequency propagation conditions between UE device(s) 10 and satellite constellation 32 and/or between satellite constellation 32 and gateway(s) 14 (e.g., due to changes in weather or other radio-frequency obstacles). It can be particularly difficult to monitor network performance in communications system 38 given that satellite constellation 32 is located in space and is generally unreachable for physical repair or in-person diagnostics, satellites 12 and UE devices 10 frequently or constantly move relative to Earth and each other over time, satellite constellation 32 might be operated by a satellite constellation operator that is different from the satcom network service provider, and different users may have/operate UE devices 10 having different hardware capabilities or conditions.

It would therefore be desirable for the satcom network service provider associated with CN 20 to be able to reliably monitor the (wireless) performance of communications system 38 in conveying wireless data via satellite constellation 32 in real-time. This may, for example, allow the satcom network service provider to identify errors or problems in the conveyance of wireless data between gateway(s) 14 and UE device(s) 10 via satellite constellation 32, to provide information identifying the errors or problems to an operator of gateway(s) 14 and/or NOC 16, to perform adjustments to one or more components in communications system 38 to correct the errors or problems, and/or to ensure that NOC 16 or the satellite constellation operator is in compliance with any guarantee, contract, or agreement (e.g., a Service Level Agreement (SLA)) in place with the satcom network service provider regarding wireless communications capabilities that are to be provided to UE device(s) 10 via satellite constellation 32.

Communications system 38 may therefore, if desired, include one or more network performance monitoring devices 40 that monitor the performance of communications system 38 in conveying wireless data via satellite constellation 32 in real-time. Network performance monitoring device(s) 40 are not UE devices and are not owned by, operated by, controlled by, or known to an end user. On the other hand, network performance monitoring device(s) 40 may be associated with (e.g., owned by, operated by, controlled by, and/or known to) the satcom network service provider associated with CN 20. Network performance monitoring devices 40 may be distributed across different locations on Earth (e.g., in different regions, states, countries, cities, or areas that are to be provided with communications capacity by satellite constellation 32).

Network performance monitoring device(s) 40 may help to monitor the network performance of satellite constellation 32 and/or gateway(s) 14 in conveying wireless data for UE device(s) 10 based on forward link signals and/or reverse link signals conveyed by satellite constellation 32. Network performance monitoring device(s) 40 may, for example, receive the DL signals 26 transmitted to UE device(s) 10 by satellite constellation 32 (e.g., forward link data in DL signals 26) and/or may transmit some of the UL signals 24 to satellite constellation 32 (e.g., reverse link data in UL signals 24). Network performance monitoring device(s) 40 may transmit information about the received forward link data (which may include the received forward link data itself) and/or information about the transmitted reverse link data (which may include the transmitted reverse link data itself) to CN 20 (e.g., via the terrestrial network and/or the satellite constellation). While conveying wireless data with UE device(s) 10 via satellite constellation 32, gateway(s) 14 may also transmit information about reverse link data received in DL signals 30 (which may include the received reverse link data itself) to CN 20 (e.g., via the terrestrial network).

CN 20 may process the information about the forward link data received by network performance monitoring device(s) 40, the information about the reverse link data transmitted by network performance monitoring device(s) 40, and/or the information about the reverse link data received by gateway(s) 14 to monitor (e.g., detect, sense, identify, characterize, and/or analyze) the performance of communications system 38 in conveying wireless data between gateway(s) 14 and UE device(s) 10 via satellite constellation 32. This may include, for example, identifying (e.g., detecting) errors, problems, or other non-idealities in satellite constellation 32 and/or gateway(s) 14 that limit, deteriorate, or otherwise impact the performance of communications system 38 in conveying wireless data between gateway(s) 14 and UE device(s) 10 via satellite constellation 32. This may, if desired, include identifying one or more points in communications system 38 that produced or are likely to have produced the identified errors, problems, or other non-idealities and/or may include transmitting information (e.g., reports) to NOC 16 and/or an operator of gateway(s) 14 identifying the errors, problems, or other non-idealities and/or the points in communications system 38 that produced or are likely to have produced the identified errors. This monitoring may also include, if desired, generating commands or control signals that instruct NOC 16, gateway(s) 14, and/or satellite constellation 32 to perform one or more adjustments in conveying wireless data with UE device(s) 10.

UE device 10 may be a computing device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses or other equipment worn on a user's head (e.g., a virtual, mixed, and/or augmented reality headset, glasses, goggles, or helmet), a ring device worn on a user's finger, or another type of wearable or miniature device, a television, a computer display that does not contain an embedded computer, a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless access point, equipment that implements the functionality of two or more of these devices, or other electronic equipment.

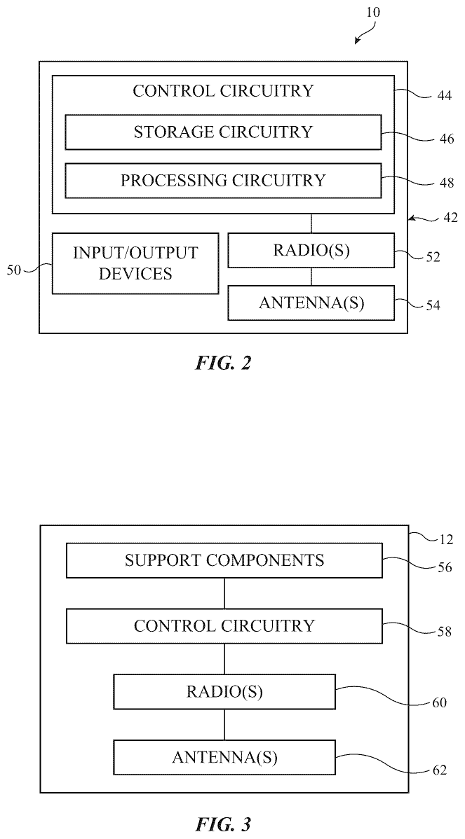

As shown in FIG. 2, UE device 10 may include components located on or within an electronic device housing such as housing 42. Housing 42, which may sometimes be referred to as a case, may be formed of plastic, glass, ceramics, fiber composites, metal (e.g., stainless steel, aluminum, metal alloys, etc.), other suitable materials, or a combination of these materials. In some situations, parts or all of housing 42 may be formed from dielectric or other low-conductivity material (e.g., glass, ceramic, plastic, sapphire, etc.). In other situations, housing 42 or at least some of the structures that make up housing 42 may be formed from metal elements.

UE device 10 may include control circuitry 44. Control circuitry 44 may include storage such as storage circuitry 46. Storage circuitry 46 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 46 may include storage that is integrated within UE device 10 and/or removable storage media.

Control circuitry 44 may include processing circuitry such as processing circuitry 48. Processing circuitry 48 may be used to control the operation of UE device 10. Processing circuitry 48 may include on one or more processors (e.g., microprocessors, microcontrollers, digital signal processors, host processors, baseband processor integrated circuits, application specific integrated circuits, central processing units (CPUs), graphics processing units (GPUs), etc.). Control circuitry 44 may be configured to perform operations in device 10 using hardware (e.g., dedicated hardware or circuitry), firmware, and/or software. Software code for performing operations on UE device 10 may be stored on storage circuitry 46 (e.g., storage circuitry 46 may include non-transitory (tangible) computer readable storage media that stores the software code). The software code may sometimes be referred to as program instructions, software, data, instructions, or code. Software code stored on storage circuitry 46 may be executed by processing circuitry 48.

Control circuitry 44 may be used to run software on UE device 10 such as satellite navigation applications, internet browsing applications, voice-over-internet-protocol (VOIP) telephone call applications, email applications, media playback applications, operating system functions, etc. To support interactions with external equipment, control circuitry 44 may be used in implementing communications protocols. Communications protocols that may be implemented using control circuitry 44 include internet protocols, wireless local area network (WLAN) protocols (e.g., IEEE 802.11 protocols-sometimes referred to as Wi-Fi®), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), antenna diversity protocols, satellite navigation system protocols (e.g., global positioning system (GPS) protocols, global navigation satellite system (GLONASS) protocols, etc.), antenna-based spatial ranging protocols (e.g., radio detection and ranging (RADAR) protocols or other desired range detection protocols for signals conveyed at millimeter and centimeter wave frequencies), satellite communications protocols, and/or any other desired communications protocols. Each communications protocol may be associated with a corresponding radio access technology (RAT) that specifies the physical connection methodology used in implementing the protocol.

UE device 10 may store satellite information associated with one or more of the satellites 12 in satellite constellation 32 on storage circuitry 46. The satellite information, sometimes referred to herein as ephemeris data or ephemeris information, may include a satellite almanac identifying the orbital parameters/position (e.g., orbit information, elevation information, altitude information, inclination information, eccentricity information, orbital period information, trajectory information, right ascension information, declination information, ground track information, etc.) and/or the velocity of satellites 12 (e.g., relative to the surface of Earth). This information may include a two-line element (TLE), for example. The TLE may identify or include information about the orbital motion of one or more of the satellites 12 in satellite constellation 32 (e.g., satellite epoch, first and/or second derivatives of motion, drag terms, etc.). The TLE may be in the format of a text file having two lines or columns that include the set of elements forming the TLE, for example. Control circuitry 44 may use the ephemeris data to calculate, predict, or identify the location of satellites 12 at a given point in time.

UE device 10 may also include wireless circuitry to support wireless communications. The wireless circuitry may include one or more antennas 54 and one or more radios 52. Each radio 52 may include circuitry that operates on signals at baseband frequencies (e.g., baseband processing circuitry, one or more baseband processors, etc.), signal generator circuitry, modulation/demodulation circuitry (e.g., one or more modems), radio-frequency transceiver circuitry (e.g., radio-frequency transmitter circuitry, radio-frequency receiver circuitry, mixer circuitry for downconverting radio-frequency signals to baseband frequencies or intermediate frequencies between radio and baseband frequencies and/or for upconverting signals at baseband or intermediate frequencies to radio-frequencies, etc.), amplifier circuitry (e.g., one or more power amplifiers and/or one or more low-noise amplifiers (LNAs)), analog-to-digital converter (ADC) circuitry, digital-to-analog converter (DAC) circuitry, control paths, power supply paths, signal paths (e.g., radio-frequency transmission lines, intermediate frequency transmission lines, baseband signal lines, etc.), switching circuitry, filter circuitry, and/or any other circuitry for transmitting and/or receiving radio-frequency signals using antenna(s) 54. The components of each radio 52 may be mounted onto a respective substrate or integrated into a respective integrated circuit, chip, package, or system-on-chip (SOC). If desired, the components of multiple radios 52 may share a single substrate, integrated circuit, chip, package, or SOC.

Antenna(s) 54 may be formed using any desired antenna structures. For example, antenna(s) 54 may include antennas with resonating elements that are formed from loop antenna structures, patch antenna structures, inverted-F antenna structures, slot antenna structures, planar inverted-F antenna structures, helical antenna structures, monopole antennas, dipoles, hybrids of these designs, etc. If desired, one or more antennas 54 may include antenna resonating elements formed from conductive portions of housing 42 (e.g., peripheral conductive housing structures extending around a periphery of a display on UE device 10). Filter circuitry, switching circuitry, impedance matching circuitry, and/or other antenna tuning components may be adjusted to adjust the frequency response and wireless performance of antenna(s) 54 over time. If desired, multiple antennas 54 may be implemented as a phased array antenna (e.g., where each antenna forms a radiator or antenna element of the phased array antenna, which is sometimes also referred to as a phased antenna array). In these scenarios, the phased array antenna may convey radio-frequency signals within a signal beam. The phases and/or magnitudes of each radiator in the phased array antenna may be adjusted so the radio-frequency signals for each radiator constructively and destructively interfere to steer or orient the signal beam in a particular pointing direction (e.g., a direction of peak signal gain). The signal beam may be adjusted or steered over time.

Transceiver circuitry in radios 52 may convey radio-frequency signals using one or more antennas 54 (e.g., antenna(s) 54 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antenna(s) 54 may transmit the radio-frequency signals by radiating the radio-frequency signals into free space (or to free space through intervening device structures such as a dielectric cover layer). Antenna(s) 54 may additionally or alternatively receive the radio-frequency signals from free space (e.g., through intervening devices structures such as a dielectric cover layer). The transmission and reception of radio-frequency signals by antenna(s) 54 each involve the excitation or resonance of antenna currents on an antenna resonating element in the antenna by the radio-frequency signals within the frequency band(s) of operation of the antenna.

Each radio 52 may be coupled to one or more antennas 54 over one or more radio-frequency transmission lines. The radio-frequency transmission lines may include coaxial cables, microstrip transmission lines, stripline transmission lines, edge-coupled microstrip transmission lines, edge-coupled stripline transmission lines, transmission lines formed from combinations of transmission lines of these types, etc. The radio-frequency transmission lines may be integrated into rigid and/or flexible printed circuit boards if desired. One or more of the radio-frequency lines may be shared between radios 52 if desired. Radio-frequency front end (RFFE) modules may be interposed on one or more of the radio-frequency transmission lines. The radio-frequency front end modules may include substrates, integrated circuits, chips, or packages that are separate from radios 52 and may include filter circuitry, switching circuitry, amplifier circuitry, impedance matching circuitry, radio-frequency coupler circuitry, and/or any other desired radio-frequency circuitry for operating on the radio-frequency signals conveyed over the radio-frequency transmission lines.

Radios 52 may use antenna(s) 54 to transmit and/or receive radio-frequency signals within different frequency bands at radio frequencies (sometimes referred to herein as communications bands or simply as a “bands”). The frequency bands handled by radios 52 may include satellite communications bands (e.g., the C band, S band, L band, X band, W band, V band, K band, Kₐ band, Kᵤ band, etc.), wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands such as sub-THz bands between around 100 GHz and around 10 THz, etc.), other centimeter or millimeter wave frequency bands between 10-300 GHz, near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, communications bands under the family of 3GPP wireless communications standards, communications bands under the IEEE 802.XX family of standards, and/or any other desired frequency bands of interest.

While control circuitry 44 is shown separately from radios 52 in the example of FIG. 2 for the sake of clarity, radios 52 may include processing circuitry that forms a part of processing circuitry 48 and/or storage circuitry that forms a part of storage circuitry 46 of control circuitry 44 (e.g., portions of control circuitry 44 may be implemented on radios 52). As an example, control circuitry 44 may include baseband circuitry or other control components that form a part of radios 52. The baseband circuitry may, for example, access a communication protocol stack on control circuitry 44 (e.g., storage circuitry 46) to: perform user plane functions at a PHY layer, MAC layer, RLC layer, PDCP layer, SDAP layer, and/or PDU layer, and/or to perform control plane functions at the PHY layer, MAC layer, RLC layer, PDCP layer, RRC, layer, and/or non-access stratum layer.

UE device 10 may include input-output devices 50. Input-output devices 50 may be used to allow data to be supplied to UE device 10 and to allow data to be provided from UE device 10 to external devices. Input-output devices 50 may include user interface devices, data port devices, and other input-output components. For example, input-output devices 50 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, orientation sensors, inertial measurement units, gyroscopes, and/or compasses that detect motion), capacitance sensors, proximity sensors, magnetic sensors, force sensors (e.g., force sensors coupled to a display to detect pressure applied to the display), temperature sensors, etc. In some configurations, keyboards, headphones, displays, pointing devices such as trackpads, mice, and joysticks, and other input-output devices may be coupled to device 10 using wired or wireless connections (e.g., some of input-output devices 50 may be peripherals that are coupled to a main processing unit or other portion of device 10 via a wired or wireless link). UE device 10 may be owned and/or operated by an end user.

A gateway 14 (FIG. 1) may include one or more radios that include one or more components similar to radio(s) 52, one or more antennas, one or more input/output devices, and control circuitry that includes one or more components similar to control circuitry 44. Unlike UE devices 10, gateway 14 is stationary and remains at a fixed location on Earth. Gateways 14 are not owned or operated by end users of UE devices 10. Gateway 14 may include one or more electronic devices such as one or more servers or terminals. The electronic device(s) of a gateway 14 may be enclosed within a housing, enclosure, building, etc.

FIG. 3 is a diagram of an illustrative satellite 12 in communications system 38. As shown in FIG. 3, satellite 12 may include satellite support components 56. Support components 56 may include batteries, solar panels, sensors (e.g., accelerometers, gyroscopes, temperature sensors, light sensors, etc.), guidance systems, propulsion systems, and/or any other desired components associated with supporting satellite 12 in orbit above Earth.

Satellite 12 may include control circuitry 58. Control circuitry 58 may be used in controlling the operations of satellite 12. Control circuitry 58 may include processing circuitry such as processing circuitry 48 of FIG. 2 and may include storage circuitry such as storage circuitry 46 of FIG. 2. Control circuitry 58 may also control support components 56 to adjust the trajectory or position of satellite 12 in space.

Satellite 12 may include antennas 62 and one or more radios 60. Radios 60 may use antennas 62 to transmit DL signals 26 and DL signals 30 and to receive UL signals 24 and UL signals 28 of FIG. 1 (e.g., in one or more satellite communications bands). Radios 60 may include transceivers, modems, integrated circuit chips, application specific integrated circuits, filters, switches, up-converter circuitry, down-converter circuitry, analog-to-digital converter circuitry, digital-to-analog converter circuitry, amplifier circuitry (e.g., multiport amplifiers), beam steering circuitry, etc.

Antennas 62 may include any desired antenna structures (e.g., patch antenna structures, dipole antenna structures, monopole antenna structures, waveguide antenna structures, Yagi antenna structures, inverted-F antenna structures, cavity-backed antenna structures, combinations of these, etc.). In some implementations, antennas 62 may include one or more phased array antennas. Each phased array antenna may include beam forming circuitry having a phase and magnitude controller coupled to each antenna element in the phased array antenna. The phase and magnitude controllers may provide a desired phase and magnitude to the radio-frequency signals conveyed over the corresponding antenna element. The phases and magnitudes of each antenna element may be adjusted so that the radio-frequency signals conveyed by each of the antenna elements constructively and destructively interfere to produce a radio-frequency signal beam (e.g., a spot beam) in a desired pointing direction (e.g., an angular direction towards Earth at which the radio-frequency signal beam exhibits peak gain). Radio-frequency lenses may also be used to help guide the radio-frequency signal beam in a desired pointing direction. Each radio-frequency signal beam also exhibits a corresponding beam width. This allows each radio-frequency signal beam to cover a corresponding area on Earth (e.g., a region on Earth overlapping the radio-frequency signal beam such that the radio-frequency signal beam exhibits a power greater than a minimum threshold value within that region/cell). Satellite 12 may convey radio-frequency signals over multiple concurrently-active signal beams if desired. If desired, satellite 12 may offload some or all of its beam forming operations to gateway 14. The signal beams may sometimes be referred to herein simply as beams.

If desired, radios 60 and antennas 62 may support communications using multiple polarizations. For example, radios 60 and antennas 62 may transmit and receive radio-frequency signals with a first polarization (e.g., a left-hand circular polarization (LHCP)) and may transmit and receive radio-frequency signals with a second polarization (e.g., a right-hand circular polarization (RHCP)). Antennas 62 may be able to produce a set of different signal beams at different beam pointing angles (e.g., where each beam overlaps a respective cell on Earth). The set of signal beams may include a first subset of signal beams that convey LHCP signals (e.g., LHCP signal beams) and a second subset of signal beams that convey RHCP signals (e.g., RHCP signal beams). The LHCP and RHCP signal beams may, for example, be produced using respective multiport power amplifiers (MPAs) on satellite 12. This is illustrative and, in general, satellite 12 may produce any desired number of signal beams having any desired polarizations.

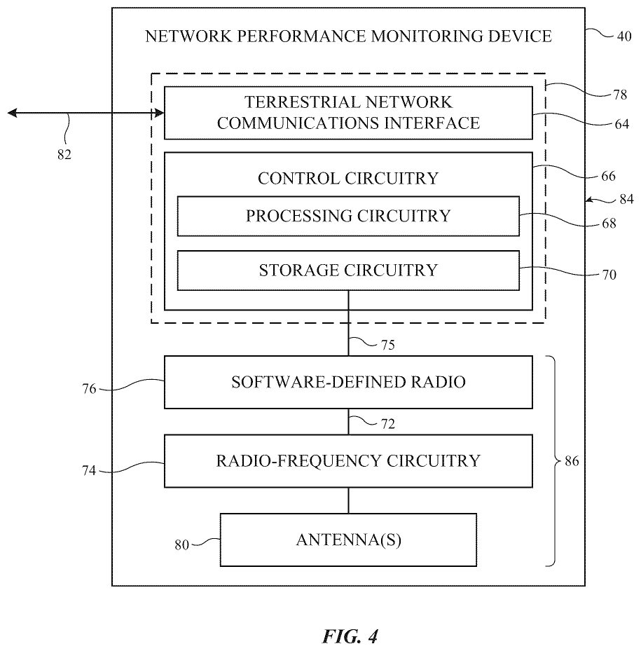

FIG. 4 is a diagram of an illustrative network performance monitoring device 40 in communications system 38. Network performance monitoring device 40 may sometimes be referred to herein as network performance monitor 40, network performance monitoring equipment 40, monitor 40, performance monitor 40, network monitor 40, network device 40, electronic device 40, network diagnostic device 40, network monitoring device 40, SLA compliance monitoring device 40, monitoring device 40, or simply as device 40. Monitoring device 40 may include one or more electronic devices that are used in monitoring, tracking, assessing, identifying, and/or analyzing the performance (e.g., wireless or radio-frequency performance) of communications system 38 in conveying wireless data between UE device(s) 10 and gateway(s) 14 via satellite constellation 32.

As shown in FIG. 4, monitoring device 40 may be enclosed within a housing (enclosure) 84. Housing 84, which may sometimes be referred to as a case, may be formed of plastic, glass, ceramics, fiber composites, metal (e.g., stainless steel, aluminum, metal alloys, etc.), other suitable materials, or a combination of these materials. In some situations, part or all of housing 84 may be formed from dielectric or other low-conductivity material (e.g., glass, ceramic, plastic, sapphire, etc.). In other situations, housing 84 or at least some of the structures that make up housing 84 may be formed from metal elements.

Monitoring device 40 may include control circuitry such as control circuitry 66. Control circuitry 66 may include storage such as storage circuitry 70. Storage circuitry 70 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 70 may include storage that is integrated within monitoring device 40 and/or removable storage media.

Control circuitry 66 may include processing circuitry such as processing circuitry 68. Processing circuitry 68 may be used to control the operation of monitoring device 40. Processing circuitry 68 may include one or more processors (e.g., microprocessors, microcontrollers, digital signal processors, host processors, baseband processor integrated circuits, application specific integrated circuits, central processing units (CPUs), graphics processing units (GPUs), etc.). Control circuitry 66 may be configured to perform operations in monitoring device 40 using hardware (e.g., dedicated hardware or circuitry), firmware, and/or software. Software code for performing operations on monitoring device 40 may be stored on storage circuitry 70 (e.g., storage circuitry 70 may include non-transitory (tangible) computer readable storage media that stores the software code). The software code may sometimes be referred to as program instructions, software, data, instructions, or code. Software code stored on storage circuitry 70 may be executed by processing circuitry 68.

Monitoring device 40 may include one or more communications interfaces such as terrestrial network communications interface 64. Terrestrial network communications interface 64 may allow monitoring device 40 to communicate with terrestrial network 34 (FIG. 1) via one or more communications links 82 (e.g., terrestrial communications link to network portion 18 of FIG. 1). Communications links 82 may include wired link and/or wireless links. Terrestrial network communications interface 64 may include one or more radios, one or more antennas, one or more data ports (e.g., Ethernet ports), cabling (e.g., coaxial cabling, Ethernet cabling, etc.) and/or any other desired equipment for communicating with terrestrial network 34 (e.g., without passing information through satellite constellation 32). If desired, terrestrial network communications interface 64 and/or control circuitry 66 may be integrated into a single device 78 within monitoring device 40. Device 78 may be a standalone device such as a desktop computer, laptop computer, cellular telephone, server, or other portable electronic device. Device 78 may be enclosed within a housing that is disposed within housing 84 if desired.

Monitoring device 40 may also include a space network communications interface 86 for communicating with gateway(s) 14 via satellite constellation 32. Space network communications interface 86 may include one or more radios. The radios may, if desired, include a software-defined radio such as software-defined radio (SDR) 76. SDR 76 may be implemented within device 78 or external to device 78 (as shown in the example of FIG. 4). SDR 76 may be coupled to control circuitry 66 over control path 75. Control path 75 may convey control signals and/or data between control circuitry 66 and SDR 76. SDR 76 is a radio that performs one or more functions of a hardware radio (e.g., mixing functions, amplification functions, modulation functions, demodulation functions, detection functions, synthesizer functions, filtering functions, etc.) using software (e.g., as executed by one or more processors such as processing circuitry 68 or other processing circuitry within SDR 76). SDR 76 may, for example, function similar to a modem that allows a computing device (e.g., device 78) to create radio-frequency energy to absorb/decode received radio-frequency energy via antenna(s) 80.

Space network communications interface 86 may also include radio-frequency hardware components such as radio-frequency circuitry 74 and one or more antennas 80. SDR 76 may be coupled to antenna(s) 80 over one or more radio-frequency transmission line path 72. Radio-frequency circuitry 74 may be disposed on radio-frequency transmission line path(s) 72 between SDR 76 and antenna(s) 80. SDR 76 may include one or more analog-to-digital converter (ADC) and/or one or more digital-to-analog converter (DAC) coupled to radio-frequency transmission line path(s) 72. Antenna(s) 80 may include any desired antennas (e.g., antennas such as antennas 54 of FIG. 2 or antennas 62 of FIG. 3). Two or more antennas 80 may be antenna elements of one or more phased array antennas if desired.

Control circuitry 66 may transmit control signals to SDR 76 that control/adjust one or more of the operations of SDR 76. The control signals may control SDR 76 to generate radio-frequency signals and to transmit the radio-frequency signals over radio-frequency transmission line path(s) 72, radio-frequency circuitry 74, and antenna(s) 80. The control signals may control SDR 76 to generate wireless data such as reverse link data that is conveyed using the radio-frequency signals (e.g., that is modulated onto the radio-frequency signals). Antenna(s) 80 may transmit the radio-frequency signals to satellite constellation 32 in IEEE bands such as the IEEE C band (4-8 GHz), S band (2-4 GHz), L band (1-2 GHz), X band (8-12 GHz), W band (75-110 GHz), V band (40-75 GHz), K band (18-27 GHz), Kₐ band (26.5-40 GHz), Kᵤ band (12-18 GHz), and/or any other desired satellite communications bands (e.g., as reverse link signals or uplink signals 24 as shown in FIG. 1). Control circuitry 66 may also transmit the transmitted reverse link data and/or information about the transmitted reverse link data to CN 20 via terrestrial network communications interface 64 and communication link(s) 82.

The wireless data may include reverse link data such as one or more reverse link data packets. The reverse link data may convey messages to CN 20 via satellite constellation 32 and gateway(s) 14. The reverse link data may include a unique identifier associated with monitoring device 40. The unique identifier may identify that the reverse link data was transmitted by a network performance monitoring device rather than a UE device 10. If desired, the reverse link data may be encoded or encrypted based on (using) the unique identifier. CN 20 may have knowledge of the unique identifier (or a decryption key associated with the unique identifier). This may allow CN 20 to identify that the reverse link data was transmitted by a network performance monitoring device rather than a UE device 10 and to decrypt the reverse link data. At the same time, this may shield other network nodes from decrypting the reverse link data or detecting that the reverse link data was transmitted by a network performance monitoring device (e.g., the reverse link data may be indistinguishable from reverse link data transmitted by a UE device 10 and/or may be unencryptable to network nodes other than (outside of) CN 20). The reverse link data may be transmitted by monitoring device 40 to allow CN 20 to monitor the network performance of satellite constellation 32 and/or gateway(s) 14.

Antenna(s) 80 may also receive forward link signals (e.g., DL signals 26 of FIG. 1) from satellite constellation 32. Antenna(s) 80 may pass the received forward link signals to SDR 76 via radio-frequency transmission line(s) 72 and radio-frequency circuitry 74. SDR 76 may demodulate the received signals to obtain (receive) wireless data from the received radio-frequency signals. The received wireless data may include forward link data. SDR 76 may pass the forward link data to control circuitry 66 for subsequent processing. Control circuitry 66 may transmit the received forward link data and/or information about the received forward link data to CN 20 via terrestrial network communications interface 64 and communication link(s) 82. CN 20 may process the forward link data or the information about the forward link data to monitor the network performance of satellite constellation 32 and/or gateway(s) 14.

Multiple monitoring devices 40 may be distributed across different locations or regions on Earth (e.g., regions that are provided with satellite communications capacity and coverage by the satellites 12 in satellite constellation 32). These regions may be regions where UE devices 10 are expected to be present. This may allow monitoring devices 40 to transmit reverse link data and/or to receive forward link data similar to as would be handled by UE devices 10 in communicating with gateway(s) 14 via satellite constellation 32. Whereas UE devices 10 transmit full-stack wireless data to and receive wireless data from end hosts of terrestrial network 34 via satellite constellation 32 and gateway(s) 14 (e.g., email data, internet browser data, streaming video data, streaming music data, messaging data, gaming data, cloud computing data, distributed processing data, etc.), monitoring devices 40 may, for example, transmit simplified data to and/or may receive data from gateway(s) 14 via satellite constellation 32 solely for the purpose of allowing CN 20 to monitor the network performance of gateway(s) 14 and/or satellite constellation 32. The network performance monitoring functions may be transparent to satellite constellation 32, gateway(s) 14, NOC 16, and any other network nodes not associated with or a part of CN 20 (e.g., the data conveyed by monitoring devices 40 via satellite constellation 32 may be indistinguishable to satellite constellation 32, gateway(s) 14, NOC 16, and any other network nodes not associated with or a part of CN 20 from data conveyed by UE devices 10).

CN 20 may include one or more servers that are located in a trusted environment. A trusted environment is secure from physical access or tampering by unauthorized persons or entities (e.g., the devices in the trusted environment may be actively attended to, monitored, and secured in a secure facility). This helps to protect data stored on the server(s) of CN 20 and data that is transmitted and received by the server(s) of CN 20 from unauthorized access. The trusted environment may, for example, include one or more secure data centers. However, in practice, CN 20 conveys data with nodes of communications system 38 that are not located in a trusted environment. If care is not taken, an unauthorized person, party, actor, or entity can gain unauthorized access to data that is stored at, transmitted to, and/or transmitted by nodes of communications system 38 that are located outside of a trusted environment.

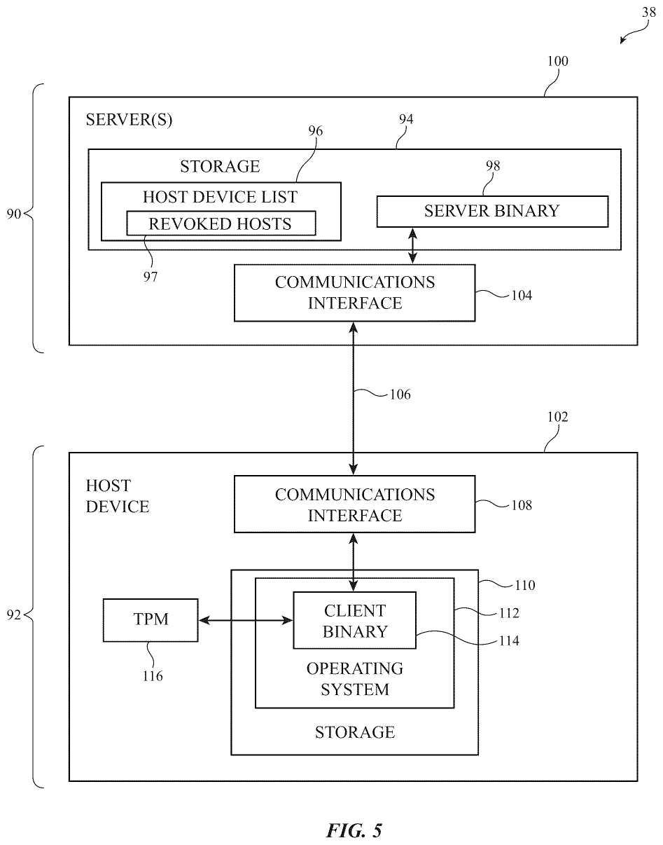

As shown in FIG. 5, for example, communications system 38 may include one or more trusted environments such as trusted environment 90. Communications system 38 may also include one or more untrusted environments such as untrusted environment 92. Trusted environment 90 may include one or more servers such as server 100. Trusted environment 90 may, for example, include CN 20 (FIG. 1). Server 100 may, for example, be a server of CN 20 that is located in a physically secured facility such as a secured data center (e.g., a data center that is only physically accessible to persons or entities of, known to, and/or authorized by the satcom network service provider associated with CN 20).

Untrusted environment 92 may include one or more devices such as host device 102. Host device 102 may communicate with server 100 in trusted environment 90 over communications path 106. Communications path 106 may include one or more wired links and/or one or more wired links (e.g., extending through terrestrial network 34 and/or constellation 32 of FIG. 1). Host device 102 may be an intended recipient (destination) of data transmitted by server 100 over communications path 106, may be a data source that transmits data to server 100 over communications path 106, and/or may be an intervening communications node that relays, routes, or forwards data between server 100 and another device such as UE device 10, monitoring device 40, gateway 14, network 31, NOC 16, an end host of network portion 18, a node of network portion 18, and/or terrestrial-based wireless communications equipment 22 of FIG. 1. Host device 102 may be any desired type of device that communicates with server 100 of trusted environment 90 and that is otherwise located in an unattended and/or insecure environment such as untrusted environment 92. Host device 102 may be, for example, a server or another electronic device in a gateway 14 (FIG. 1), a server or another electronic device in network 31 (e.g., a CDN), a server or another electronic device in NOC 16, a monitoring device 40, an unattended UE device 10 located in an untrusted environment, etc.

Unlike trusted environment 90, untrusted environment 92 is not physically secure from access by unauthorized persons or entities. This means that host device 102 may be left unattended for a prolonged period of time, during which host device 102 can be physically accessed or tampered with by an unauthorized party. If care is not taken, this physical access can undesirably expose, to the unauthorized party, data stored on host device 102 (e.g., data physically located in untrusted environment 92), data transmitted by host device 102 (e.g., to server 100 or another device in a trusted environment), and/or data received by host device 102 (e.g., from server 100 or another device in a trusted environment). For example, if care is not taken, an unauthorized party might be able to obtain proprietary, secret, private, and/or privileged information stored on host device 102 and/or transmitted by server 100 to host device 102. The unauthorized party might also be able to obtain persistence, receive unauthorized services from server 100, and/or capture sensitive data. This can impair data privacy for the owner/operator of host device 102 and/or can effectively limit the security provided by server 100 in communicating with or via host device 102, even though server 100 is located in a trusted environment.

As shown in FIG. 5, server 100 may include storage 94 (e.g., storage circuitry such as storage circuitry 46 of FIG. 2) and communications interface circuitry such as communications interface 104 (e.g., wired and/or wireless communications circuitry that communicates with host device 102 over communications path 106). Storage 94 may store server software such as server binary 98. Processing circuitry on server 100 (not shown in FIG. 5 for the sake of clarity) may control communications interface 104 to convey data over communications path 106 and may execute server binary 98. Upon execution, server binary 98 may generate data that is transmitted over communications path 106 via communications interface 104 and/or may process data that is received over communications path 106 via communications interface 104.

Storage 94 may also store a host device list such as host device list 96. Host device list 96 may include a list of host devices 102 in communications system 38 that are known to server 100, that are enrolled in services provided by server 100, and/or that otherwise communicate with server 100. If desired, host device list 96 may also include a list of revoked hosts such as list 97. List 97 may include the identity of host devices 102 (e.g., unique host identifiers) that have had their secure access to data communications and/or services with server 100 revoked (e.g., due to the passage of time, due to security threats posed by the revoked devices, due to inclusion of the identity on a security black list or threat list, due to a report received from an operator of host device 102 indicating that host device has been lost or compromised, due to a request from an operator of host device 102 or CN 20, due to the revoked devices unenrolling from services provided by server 100, due to a security policy implemented by server 100, etc.). Server 100 may add new host devices 102 to list 97 and/or may remove host devices 102 from list 97 over time. Host device list 96 and the list of revoked devices 97 may be implemented using one or more databases, tables, and/or any other desired data structures.

The example of FIG. 5 illustrates host device list 96, list 97, and server binary 98 as being located in the same server as communications interface 104 for the sake of simplicity. If desired, host device list 96, list 97, and/or server binary 98 may be distributed across two or more servers 100 in trusted environment 90 (e.g., CN 20 of FIG. 1). Put differently, server 100 may be implemented using a single physical device or may be implemented as a logically defined server that overlies two or more physical devices in trusted environment 90.

Host device 102 may include storage 110 (e.g., storage circuitry such as storage circuitry 46 of FIG. 2) and communications interface circuitry such as communications interface 108 (e.g., wired and/or wireless communications circuitry that communicates with server 100 over communications path 106). Storage 110 may store software such as an operating system (OS) 112 of host device 102. Storage 110 may also store client software such as client binary 114. Client binary 114 may be included within operating system 112 (e.g., stored as a part of operating system 112), may be separate from operating system 112 (e.g., stored separately from operating system 112 in storage 110), and/or may be executed by operating system 112.

Host device 102 may also include a secured storage module such as trusted platform module (TPM) 116. Client binary 114 may be communicatively coupled to TPM 116 over a first communications path in host device 102 and may be communicatively coupled to communications interface 108 over a second communications path in host device 102 (e.g., host device 102 may include a communications or signal bus that includes the first and second communications paths). Processing circuitry on host device 102 (not shown in FIG. 5 for the sake of clarity) may control communications interface 108 to convey data over communications path 106 and may execute operating system 112 and client binary 114. Upon execution, client binary 114 may generate data that is transmitted to server binary 98 over communications path 106 via communications interface 104 and/or may process data that is received from server binary 98 over communications path 106 via communications interface 104.

TPM 116 is a tamper-proof and secure hardware storage module (e.g., an integrated circuit chip, module, or package) that stores information utilized by host device 102 in performing secure communications and/or data storage. Some or all of the information may be hardcoded and/or otherwise protected to prevent that information from being erased, overwritten, read, and/or removed from TPM 116. TPM 116 may only be accessed by operating system 112 and is not directly accessible over the network or by other devices external to host device 102. TPM 116 may include storage circuitry (e.g., one or more integrated circuits having encrypted storage, storage circuitry 46 of FIG. 2, etc.) that is separate from storage 110. TPM 116 may store one or more cryptographic keys that are used by client binary 114 when needed, but that are otherwise inaccessible as stored on TPM 116 (e.g., even to unauthorized parties with physical access to host device 102). One or more of the cryptographic keys may, for example, be hardcoded in encrypted storage in TPM 116. TPM 116 may be mounted to the same logic board, printed circuit board, package, or substrate a storage 110. Alternatively, TPM 116 and storage 110 may be mounted to different logic boards, printed circuit boards, packages, or substrates.

Client binary 114 may access information stored on TPM 116 to help increase the security of host device 102 while left unattended, despite host device 102 being located in an untrusted environment. Client binary 114 may, for example, access information stored on TPM 116 that is used in performing secure communications with server 100 and/or that is used in encrypting and decrypting some or all of the storage 110 on host device 102.

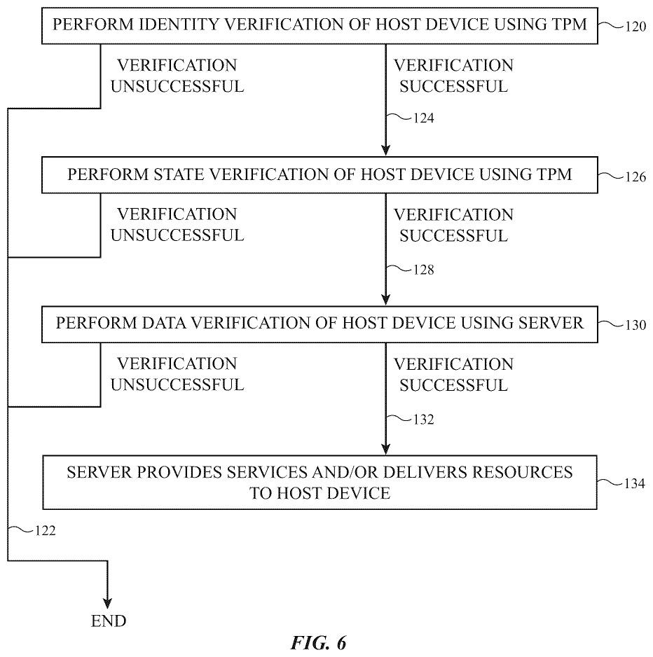

FIG. 6 is a flow chart of operations involved securely transmitting a data payload from server 100 in trusted environment 90 to host device 102 in untrusted environment 92 (e.g., using TPM 116 as accessed by client binary 114). The operations of FIG. 6 may, for example, be performed after host device 102 has initiated bring-up, after operating system 112 has been installed on storage 110, and after host device 102 has requested data (e.g., a data payload) from server 100.

At operation 120, client binary 114 on host device 102 may use information stored on TPM 116 to verify the hardware identity of host device 102 to server binary 98 on server 100 (sometimes also referred to herein as performing an identity verification of host device 102). The identity verification may, for example, allow server 100 to verify who the server is communicating with prior to transmitting sensitive data to host device 102 (e.g., helping to prevent identity spoofing and reducing pivoting opportunities).

The identity verification may involve, for example, server 100 transmitting a key custody challenge to host device 102. Client binary 114 may interface with TPM 116 to solve and respond to the key custody challenge, which verifies the hardware identity of host device 102 to server binary 98 and server 100. If/when server 100 is unable to verify the identity of host device 102 (e.g., responsive to host device 102 failing the key custody challenge), processing may proceed over path 122 and server 100 may forego providing data or services to host device 102. If/when server 100 is able to verify the identity of host device 102 (e.g., responsive to host device 102 passing the key custody challenge), processing may proceed from operation 120 to operation 126 via path 124.

At operation 126, client binary 114 on host device 102 may use information stored on TPM 116 to verify the hardware and software state of host device 102 to server binary 98 on server 100 (sometimes also referred to herein as performing a state verification of host device 102). The state verification may allow server 100 to verify how host device 102 is configured prior to transmission sensitive data to the host device. The hardware and software state may include information identifying the present configuration of hardware and/or software on host device 102 (e.g., the hardware capabilities of host device 102, particular hardware devices plugged into or mounted to host device 102, the particular operating system of host device 102, other software running on host device 102, etc.).

The state verification may include, for example, host device 102 identifying its hardware and software state using a platform configuration register (PCR) quoting or measured booting scheme. The state may, if desired, be maintained in one or more registers on TPM 116 that are signed by a cryptographic key that is stored on TPM 116 and that is never output by TPM 116. State verification may, for example, help to mitigate an unauthorized party from obtaining persistence, to prevent equipment tampering at host device 102, and to enforce disk encryption (e.g., even if an unauthorized device were able to spoof the identity of host device 102, it is nearly impossible for the unauthorized device to also spoof the state of host device 102). If/when server 100 is unable to verify the state of host device 102, processing may proceed over path 122 and server 100 may forego providing data or services to host device 102. If/when server 100 is able to verify the state of host device 102, processing may proceed from operation 126 to operation 130 via path 128.

At operation 130, server binary 98 on server 100 may perform data verification for host device 102 using information received from host device 102 (sometimes also referred to herein as performing a data verification for host device 102). This may include, for example, verifying that the state of host device 102 (as verified at operation 126) aligns with the identity of host device 102 (as verified at operation 120) and the data payload to be transmitted to host device 102. This may help to ensure, for server 100, that host device 102 is the expected and authorized host device for the data payload instead of an unauthorized device that forged a request for the data payload from server 100. If/when server 100 is unable to successfully perform data verification, processing may proceed over path 122 and server 100 may forego providing data or services to host device 102. If desired, server 100 may add host device 102 to its list of revoked hosts 97 if/when processing proceeds along path 122 from any of operations 120-130. If/when server 100 is able to successfully perform data verification, processing may proceed from operation 130 to operation 134 via path 132.

At operation 134, server 100 may begin to provide secure data services to host device 102. This may include, for example, transmitting the data payload requested by host device 102 to host device 102 (e.g., over communications path 106 of FIG. 5). Host device 102 may store, install, persist, enumerate, and/or process the data payload. If desired, host device 102 may forward, transmit, and/or relay the data payload to an intended recipient (e.g., a UE device 10 of FIG. 1, an end host of network portion 18, etc.).

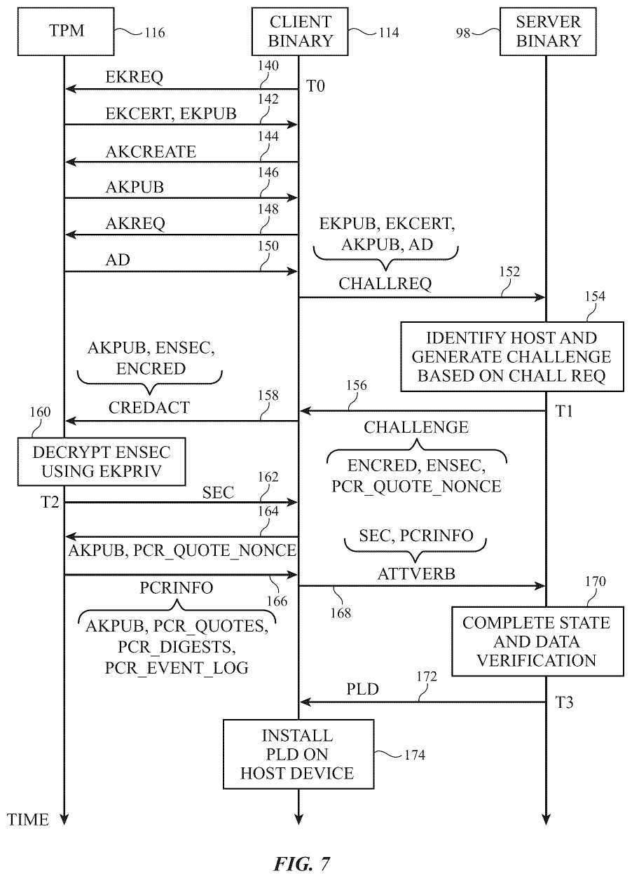

FIG. 7 is a timing diagram of illustrative operations and signals involved in securely transmitting a data payload from server 100 in trusted environment 90 to host device 102 in untrusted environment 92 (e.g., while processing the operations of FIG. 6). Time is plotted on the vertical axis of FIG. 7. The portion of FIG. 7 between times T0 and T2 may, for example, occur while processing operation 120 of FIG. 6 (e.g., while performing identity verification for host device 102). The portion of FIG. 7 between times T2 and T3 may, for example, occur while processing operations 126 and 130 of FIG. 6 (e.g., while performing state and data verification for host device 102). The portion of FIG. 7 after time T3 may, for example, occur while processing operation 134 of FIG. 6. Because TPM 116 is not accessible by other devices on the network, client binary 114 may serve as an interface that provides some of the information stored on TPM 116 to server binary 98 on server 100 (FIG. 5) for verifying host device 102.

As shown in FIG. 7, at time TO, client binary 114 on host device 102 may transmit an endorsement key request EKREQ to TPM 116, as shown by arrow 140 (e.g., using a TPM2_GetEK( ) command). TPM 116 may securely store cryptographic keys such as an endorsement key pair (e.g., a key pair that is hardcoded into TPM 116 by the manufacturer of TPM 116, which may be different than the manufacturer of host device 102). The endorsement key pair may include a private endorsement key EKPRIV that is never output by TPM 116, a corresponding public endorsement key EKPUB that is output by TPM 116 when needed, and a corresponding endorsement key certificate EKCERT that is output by TPM 116 when needed. The private endorsement key, public endorsement key EKPUB, and endorsement key certificate EKCERT may, for example, be hardcoded into TPM 116 upon manufacture and may not be replaced, erased, or overwritten on TPM 116. TPM 116 may, if desired, have one or more application programming interfaces (APIs) that are accessible to client binary 114 (e.g., to allow client binary 114 to access information stored at TPM 116, to instruct TPM 116 to perform one or more actions, etc.). APIs associated with TPM 116 are sometimes also referred to herein as TPM APIs.

In response to receiving endorsement key request EKREQ (sometimes also referred to herein as endorsement key request signal EKREQ or endorsement key request message EKREQ), TPM 116 may transmit its stored public endorsement key EKPUB and its stored endorsement key certificate EKCERT to client binary 114, as shown by arrow 142. In response to receiving public endorsement key EKPUB and endorsement key certificate EKCERT from TPM 116, client binary 114 may transmit an attestation key creation request AKCREATE to TPM 116 (e.g., using a TPM2_CreateAK command of the TPM API). Attestation key creation request AKCREATE (sometimes also referred to herein as attestation key creation request signal AKCREATE or attestation key creation request message AKCREATE) may include or otherwise identify the public endorsement key EKPUB received by client binary 114 from TPM 116.

Attestation key creation request AKCREATE may instruct, trigger, and/or control TPM 116 to generate a public attestation key AKPUB based on public endorsement key EKPUB. Public attestation key AKPUB may be unique (e.g., the cryptographic function utilized by TPM 116 to generate public attestation key AKPUB may output a different/unique public attestation key AKPUB each time it is executed). As shown by arrow 146, TPM 116 may transmit the generated public attestation key AKPUB to client binary 114.

In response to receiving public attestation key AKPUB, client binary 114 may transmit an attestation data request ADREQ to TPM 116, as shown by arrow 148 (e.g., using a TPM2_Create Attestation command of the TPM API). Attestation data request ADREQ (sometimes also referred to herein as attestation data request signal ADREQ or attestation data request message ADREQ) may include or otherwise identify the public attestation key AKPUB received from TPM 116. Attestation data request ADREQ may instruct, trigger, and/or control TPM 116 to generate and transmit attestation data AD to client binary 114 (e.g., in an attestation data dump). As shown by arrow 150, TPM 116 may transmit attestation data AD to client binary 114 in response to receiving attestation data request ADREQ. The attestation data AD transmitted to client binary 114 may include, as examples, an attestation data structure that contains one or more fields of attestation data (e.g., TPMS_CREATION_DATA, TPMS_ATTEST, TPMT_SIGNATURE, etc.).

In response to receiving attestation data AD, client binary 114 may generate and transmit a challenge request CHALLREQ to server binary 98, as shown by arrow 152. Challenge request CHALLREQ (sometimes also referred to as challenge request message CHALLREQ or challenge request signal CHALLREQ) may include or otherwise identify the public endorsement key EKPUB, the endorsement key certificate EKCERT, the public attestation key AKPUB, and the attestation data AD received, retrieved, and/or fetched by client binary 114 from TPM 116.

In response to receiving challenge request CHALLREQ from client binary 114, server binary 98 may perform operation 154. At operation 154, server binary 98 may identify host device 102 based on the received challenge request CHALLREQ and may generate a corresponding challenge based on the received challenge request CHALLREQ. This may include, for example, verifying the signing of the endorsement key certificate EKCERT in challenge request CHALLREQ (e.g., using a certificate service in trusted environment 90) and looking up the identity associated with the verified endorsement key certificate EKCERT.

In response to verifying the signing of endorsement key certificate EKCERT, server binary 98 may generate an encrypted secret ENSEC that should only be decryptable by an identity-verified host device 102. Server binary 98 may generate encrypted secret ENSEC by encrypting (wrapping) an unencrypted secret SEC using the endorsement public key EKPUB from the received challenge request CHALLREQ, for example. If desired, server binary 98 may also generate a corresponding encrypted credential ENCRED. Unencrypted secret SEC may include a series or string of bits, digits, or characters. Unencrypted secret SEC may, for example, be a 32 byte secret value. Server binary 98 may also generate a single-use nonce value to be used by host device 10 in performing state verification, such as a PCR nonce PCR_QUOTE_NONCE.

At time T1, as shown by arrow 156, server binary 98 may transmit the requested and generated challenge to client binary 114. The transmitted challenge (sometimes also referred to herein as a challenge signal or a challenge message) may include the encrypted secret ENSEC, PCR nonce PCR_QUOTE_NONCE, and encrypted credential ENCRED. In response to receiving the challenge, client binary 114 may transmit a credential activation signal CREDACT (sometimes also referred to herein as credential activation message CREDACT) to TPM 116, as shown by arrow 158 (e.g., using a TPM2_ActivateCredential command of the TPM API). Credential activation signal CREDACT may include, for example, the attestation public key AKPUB received by client binary 114 between times T0 and T1, the encrypted secret ENSEC in the challenge received from server binary 98, and the corresponding encrypted credential ENCRED in the challenge received from server binary 98.

At operation 160, TPM 116 (e.g., one or more processors on TPM 116) may decrypt the encrypted secret ENSEC received from client binary 114 using the private endorsement key EKPRIV stored on TPM 116, which generates, recovers, and/or unwraps the corresponding unencrypted (decrypted) secret SEC. Decrypting encrypted secret ENSEC at TPM 116 may prevent exposure of private endorsement key EKPRIV to devices or actors external to TPM 116 and host device 102. At time T2, TPM 116 may transmit the decrypted secret SEC to client binary 114, as shown by arrow 162.

In response to receiving the decrypted secret SEC, client binary 114 may transmit, to TPM 116, the public attestation key AKPUB received from TPM 116 between times T0 and T1 and the PCR nonce PCR_QUOTE_NONCE in the challenge received from server binary 98, as shown by arrow 164 (e.g., using a TPM2_Quote command of the TPM API). TPM 116 may then generate PCR information PCRINFO based on the public attestation key AKPUB and the PCR nonce PCR_QUOTE_NONCE received from client binary 114. As shown by arrow 166, TPM 116 may transmit PCR information PCRINFO to client binary 114. PCR information PCRINFO may include, for example, public attestation key AKPUB, one or more PCR quote values PCR_QUOTES, one or more PCR digests PCR_DIGESTS, and one or more PCR event logs PCR_EVENT_LOG. This information may be indicative of the present hardware and/or software state of TPM 116 and/or host device 102.

In response to receiving PCR information PCRINFO, client binary 114 may transmit a request ATTVERB to server binary 98, as shown by arrow 168. Request ATTVERB may include, for example, the decrypted secret SEC received and the PCR information PCRINFO received from TPM 116. Request ATTVERB (sometimes also referred to herein as request signal ATTVERB, request message ATTVERB, or action request ATTVERB) may include a request that server binary 98 perform a desired action or service (e.g., an attested verb) for host device 102 using the decrypted secret SEC and the received PCR information PCRINFO. The action or verb may include, as three examples, a provisioning service, a bootstrap service, or a renew service. The request may correspond to a particular data payload to be provided to host device 102 (e.g., request ATTVERB is sometimes also referred to herein as a request for a data payload).

A request for a provisioning service may be a hardware-specific request that server binary 98 provision and vend (transmit) a particular data payload or type of data payload to host device 102 (e.g., a particular software package, intellectual property (IP) block, other secure or sensitive data, etc.). A request for a bootstrap service may be a role-specific request that server binary 98 use a data payload to configure host device 102 to execute software that performs a specific role. A request for a renew service may be a request that server binary 98 vend a data payload to host device 102 that expires (e.g., a request to replace a certificate that is stored at host device 102 and that is valid for a certain amount of time with a renewed certificate).

At operation 170, server binary 98 may complete state and data verification based on the request ATTVERB received from client binary 114. This may include, for example, verifying that the decrypted secret SEC received from client binary 114 matches the unencrypted secret SEC used by server binary 98 to generate encrypted secret ENSEC (e.g., as generated while processing operation 154), asserting a PCR quoted by the PCR quote(s) PCR_QUOTES in the request ATTVERB received from client binary 114, asserting PCR digests not tampered with, and/or asserting PCR digests that match for the attested verb requested by request ATTVERB. By the end of processing operation 170, server binary 98 may verify that the state of host device 102 matches the identity of host device 102 (e.g., as verified at operation 154) and the requested data payload PLD.

At time T3 (e.g., responsive to successful state and data verification of host device 102), server binary 98 may transmit the requested data payload PLD to client binary 114, as shown by arrow 172. Data payload PLD may include one or more hardware configurations, software configurations, configuration bundles, software files, operating system files, operating systems, software packages, scripts, IP blocks, communications data (e.g., a stream of data packets, frames, symbols, datagrams, etc.), and/or any other desired secure or sensitive data to be stored at, processed by, and/or forwarded by host device 102. At operation 174, the operating system on host device 102 may install (e.g., may persist one or more configuration bundles), process, and/or forward data payload PLD and/or may otherwise configure hardware and/or software on host device 102 using data payload PLD. If desired, data payload PLD may also include a corresponding host name. If desired, client binary 114 may print the host name to stdout and/or may otherwise produce an output indicating that data payload PLD has been installed or processed by host device 102.

This may allow server 100 to verify that it transmitted data payload PLD to a verified host device 102 rather than to an unauthorized device attempting to spoof or pose as host device 102. Server 100 may also perform secure, authenticated, and verified identity provisioning, identity revocation (e.g., adding host device 102 to the list of revoked hosts 97 of FIG. 5), credential renewal, and/or service bootstrapping definition with host device 102. If desired, the operations of server 100 may be monitored (e.g., by an authorized party or device) within trusted environment 90 (e.g., using chat tools, audit logs, etc.). In this way, server 100 may perform secure and verified communications with host device 102 that are protected from the various security risks associated with physical access to host device 102 in untrusted environment 92. These mitigated security risks include, for example, direct memory access card installation at host device 102 (e.g., where an unauthorized person installs a memory card into host device 102), simple drive removal (e.g., where an unauthorized person removes a storage drive from host device 102), malicious device firmware (e.g., where an unauthorized person installs malicious firmware on host device 102), TPM bus sniffing (e.g., where an unauthorized person installs hardware to intercept signals conveyed over the bus between TPM 116 and client binary 114), operating system tampering, foundational signing request spoofing, etc.

To help bolster the security of host device 102 in untrusted environment 92, some or all of storage 110 may be encrypted at rest. This means that the storage remains encrypted and inaccessible to persons with physical access to host device 102 even while host device 102 is powered off. Once host device 102 is powered on, host device 102 may interface with server 100 to remotely enable host device 102 to decrypt its encrypted storage in a secure manner. Server 100 may remotely enable host device 102 to decrypt its storage only if server 100 is able to successfully verify the identity of host device 102 and if host device 102 is not included on the list of revoked hosts 97 (FIG. 5). On the other hand, if server 100 is unable to successfully verify the identity of host device 102 or if host device 102 is included in the list of revoked hosts 97, server 100 may refuse or forego remotely enabling host device 102 to decrypt its storage, leaving any data on the encrypted storage inaccessible to unauthorized parties.

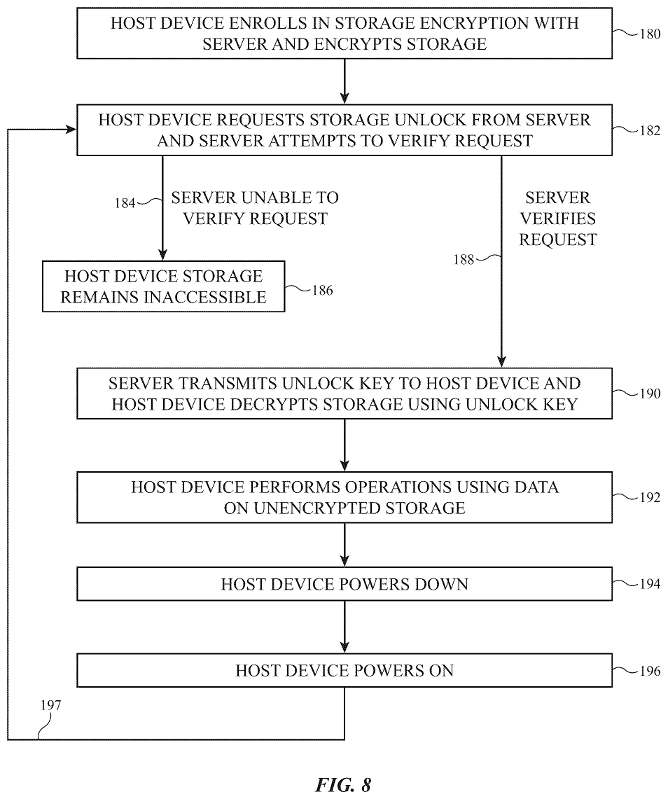

FIG. 8 is a flow chart of illustrative operations involved in using server 100 to remotely allow host 102 to encrypt and decrypt its storage 110. The operations of FIG. 8 may be performed independently of the operations of FIGS. 6 and 7 if desired. The operations of FIG. 8 may be performed prior to, concurrent with, and/or after some or all of the operations in FIGS. 6 and 7.

At operation 180 of FIG. 8, host device 102 may enroll in storage encryption with server 102. Host device 102 may encrypt some or all of storage 110 (e.g., one or more disk volumes of storage 110, all the disk volumes in storage 110, etc.) using one or more cryptographic keys generated by TPM 116 and/or received from server 100. After processing operation 180, the encrypted portion(s) of storage 110 may remain encrypted, locked, and inaccessible, including while host device 102 is powered off, until the encrypted portion(s) of storage 110 are decrypted (unlocked).

At operation 182, after host device 102 has been powered on, host device 102 may request that server 100 allow host device 102 to unlock the encrypted portion(s) of storage 110. Server 100 may attempt to verify the request and host device 102. If/when server 100 is unable to verify the request or host device 102 (e.g., because host device 102 is not an authentic or expected host device or because host device 102 is on the list of revoked hosts 97), processing may proceed to operation 186 via path 184. At operation 186, server 100 may forego transmitting further signals to host device 102 that would otherwise allow host device 102 to decrypt the encrypted portion(s) of storage 110. The encrypted portion(s) of storage 110 may remain encrypted and inaccessible. Processing may also proceed to operation 186 if/when host device 102 is offline or otherwise unable to communicate with server 100.

On the other hand, if/when server 100 is able to verify the request and host device 102, processing may proceed to operation 190 via path 188. At operation 190, server 100 may transmit a cryptographic key (sometimes also referred to herein as an unlock key or a storage key) to host device 102. Host device 102 may use the received cryptographic key to decrypt (unlock) the encrypted portion(s) of storage 110.

At operation 192, host device 102 may perform any desired operations (e.g., secured services) using data on the unencrypted portion(s) of storage 110. This may include, if desired, reading data from the unencrypted portion(s) of storage 110, writing data to the unencrypted portion(s) of storage 110, overwriting data on the unencrypted portion(s) of storage 110, installing software on the unencrypted portion(s) of storage 110, renewing or bootstrapping data on the unencrypted portion(s) of storage 110, transmitting and/or forwarding data on the unencrypted portion(s) of storage 110 to another device, etc.

At operation 194, host device 102 may power down. The portion(s) of storage 110 that were unencrypted at operation 190 may become encrypted (locked) when host device 102 powers down, helping to protect the data on storage 110 from unauthorized actors with physical access to host device 102.

At operation 196, host device 102 may power on. Processing may then loop back to operation 182 via path 197 to allow host device 102 to access the encrypted portion(s) of storage 110.

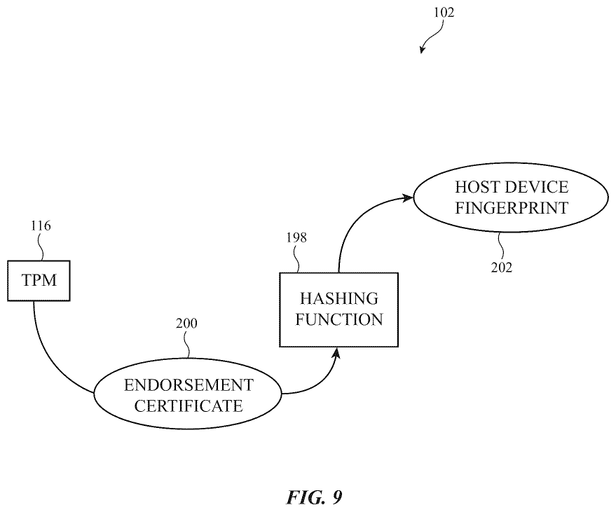

To help server 100 verify host device 102 (e.g., while processing operations 180 and 182 of FIG. 8), host device 102 may use TPM 116 to generate a cryptographic fingerprint that is unique to host device 102. FIG. 9 is a diagram showing one example of how host device 102 may generate a cryptographic fingerprint that is unique to host device 102.

As shown in FIG. 9, host device 102 may include circuitry that performs a cryptographic function such as hashing function 198 (e.g., dedicated hashing logic, cryptographic circuitry, one or more processors that perform the hashing function, etc.). Hashing function 198 may perform a cryptographic hashing operation (sometimes referred to simply as a hash) on an input. TPM 116 may output an endorsement certificate 200 and may provide endorsement certificate 200 to hashing function 198. Endorsement certificate 200 may be hardcoded on TPM 116 (e.g., by the manufacturer of TPM 116). Endorsement certificate 200 may be, for example, endorsement key certificate EKCERT of FIG. 7. Hashing function 198 may hash endorsement certificate 200 to generate a corresponding cryptographic fingerprint such as host device fingerprint 202 (e.g., host device fingerprint 202 may be a hash value of endorsement certificate 200). Host device fingerprint 202 may be unique to host device 102 and is sometimes also referred to herein simply as fingerprint 202.

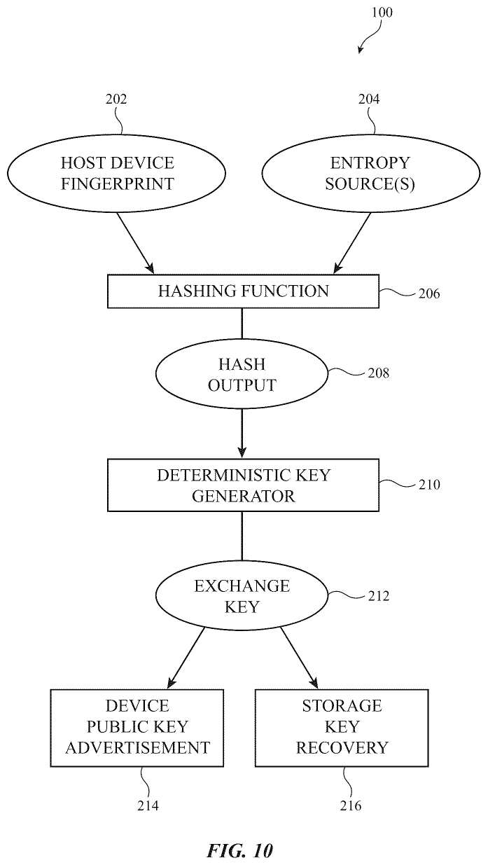

To help server 100 verify host device 102 (e.g., while processing operations 180 and 182 of FIG. 8), server 100 may use the fingerprint 202 generated by host device 102 to generate an exchange key that is unique to host device 102. FIG. 10 is a diagram showing one example of how server 100 may generate an exchange key that is unique to host device 102.

As shown in FIG. 10, server 100 may input fingerprint 202 and one or more data/key entropy sources 204 to a cryptographic algorithm such as hashing function 206. Hashing function 206 may hash fingerprint 202 with entropy source(s) 204 to generate a corresponding hash output 208. Entropy source(s) 204 may include any desired cryptographic exchange key entropy sources (e.g., random data, pseudorandom data, temporal data, global and rotatable static crypto-pseudorandom entropies, etc.). The entropy/randomness of entropy source(s) 204 and fingerprint 202 may introduce corresponding randomness or pseudo randomness to hash output 208 that is difficult or nearly impossible to spoof (e.g., hash output 208 may include derived entropies due to the input of entropy source(s) 204 to hashing function 206).

Server 100 may also include cryptographic key pair generation circuitry such as deterministic key generator 210. Deterministic key generator 210 may generate a cryptographic key pair that is deterministic and unique to host device 102 based on hash output 208. The deterministic key pair may include an exchange key 212 (e.g., a public key of the deterministic key pair) that is unique to host device 102. The uniqueness of exchange key 212 to host device 102 is derived from the inclusion of host device fingerprint 202, which is generated by host device 102 based on an endorsement certificate 200 (FIG. 9) that is unique to its TPM 116, in the hash output 208 that is provided to deterministic key generator 210. Server 100 may provide exchange key 212 to device public key advertisement block 214 (e.g., to advertise or transmit the exchange key) and/or to storage key recovery block 216 (e.g., for use in generating/recovering a storage key used by host device 102 to decrypt the encrypted portion(s) of its storage 110).

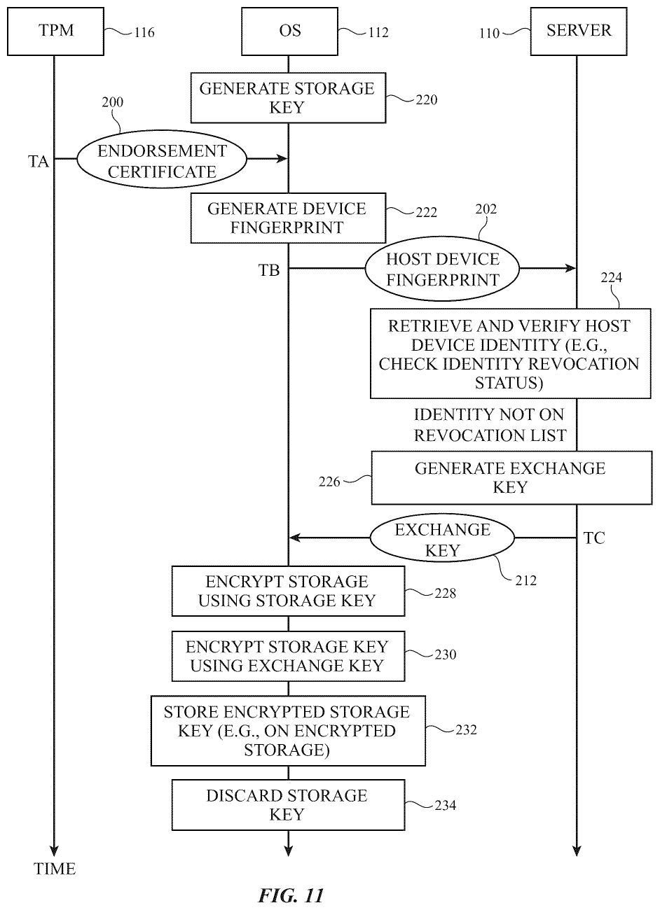

FIG. 11 is a timing diagram of illustrative operations and signals involved in enrolling host device 102 in storage encryption and encrypting/locking storage 110 on host device 102 using TPM 116 and server 100 (e.g., while processing operation 180 of FIG. 8). The middle column of FIG. 11 illustrates operations that are described as being performed by OS 112 on host device 102 for the sake of simplicity. These operations may be performed by client binary 114 (FIG. 5) and/or any other desired processing circuitry and/or software on host device 102 (e.g., external to TPM 116).

As shown in FIG. 11, at operation 220, OS 112 may generate a storage key 221 for the portion(s) of storage 110 to be encrypted (e.g., some or all of storage 110). At time TA, OS 112 may receive endorsement certificate 200 from TPM 116. If desired, OS 112 may request or fetch endorsement certificate 200 from TPM 116 prior to time TA.

In response to receiving endorsement certificate 200, at operation 222, OS 112 may generate device fingerprint 202. For example, OS 112 may input the endorsement certificate 200 received from TPM 116 into hashing function 198 (FIG. 9), which outputs fingerprint 202. Fingerprint 202 is unique to host device 102 because endorsement certificate 200 is unique to the TPM 116 installed on host device 102. At time TB, OS 112 may transmit host device fingerprint 202 to server 100 (e.g., over communications path 106 of FIG. 5).

In response to receiving fingerprint 202 from host device 102, server 100 may retrieve and verify the identity of host device 102 using the received fingerprint 202 (at operation 224). If desired, server 100 may compare the identity of host device 102 (e.g., as identified based on fingerprint 202) to the list of revoked hosts 97 (FIG. 5). If/when server 100 determines that the identity of host device 102 is included on the list of revoked hosts 97, server 100 may discard the fingerprint and forego the remaining operations of FIG. 11 (e.g., processing may proceed to operation 186 of FIG. 8). If/when server 100 determines that the identity of host device 102 is not included on the list of revoked hosts 97, processing may proceed to operation 240.

At operation 226, server 100 may generate a deterministic key pair that is unique to host device 102 based on fingerprint 202. This may include, for example, generating hash output 208 using fingerprint 202, entropy source(s) 204, and hashing function 206, and then inputting hash output 208 to deterministic key generator 210 (FIG. 10). The deterministic key pair may include exchange key 212, which is unique to host device 102. At time TC, server 100 may transmit the generated exchange key 212 to OS 112 (e.g., over communications path 106 of FIG. 5).

In response to receiving exchange key 212, at operation 228, OS 112 may use its generated storage key 221 to encrypt some or all of the storage 110 on host device 102, producing the encrypted portion(s) of storage 110. Storage key 221 is never transmitted outside of host device 102 unencrypted, helping to protect the storage key from unauthorized parties.

At operation 230, OS 112 may use the exchange key 212 received from server 100 to encrypt its storage key 221. This encryption generates an encrypted storage key 221′ (e.g., storage key 221 in ciphertext rather than plaintext). At operation 232, OS 112 may store encrypted storage key 221′. If desired, OS 112 may store encrypted storage key 221′ in the encrypted portion(s) of storage 110. At operation 234, OS 112 may discard (e.g., erase, delete, etc.) storage key 221. In this way, storage key 221 is never stored anywhere on host device 102 or external to host device 102 in an unencrypted form. This may help prevent exposing data on the encrypted portion(s) of storage 110 from unauthorized parties, even while host device 102 is powered off.

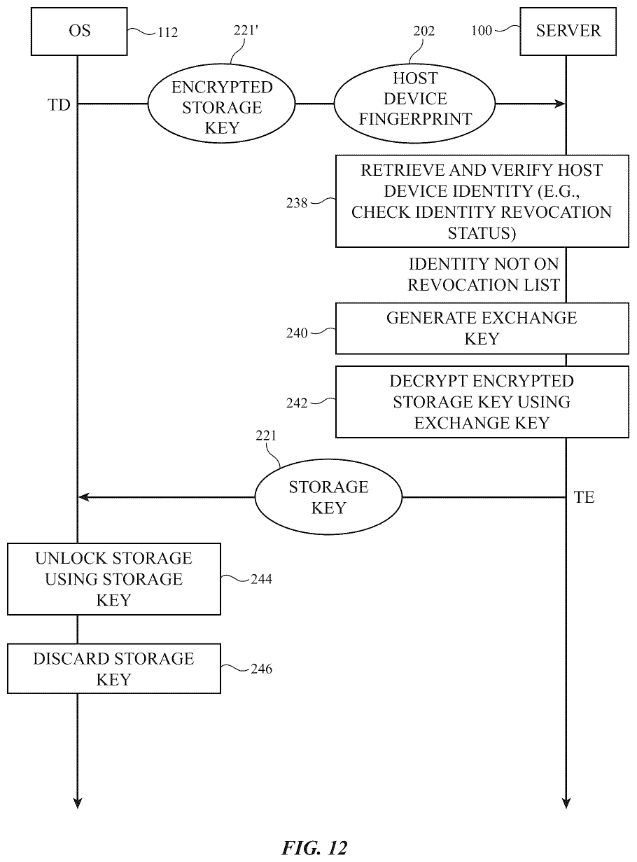

FIG. 12 is a timing diagram of illustrative operations and signals decrypting/unlocking storage 110 on host device 102 using TPM 116 and server 100 (e.g., while processing operations 182-190 of FIG. 8). The left column of FIG. 12 illustrates operations that are described as being performed by OS 112 on host device 102 for the sake of simplicity. These operations may be performed by client binary 114 (FIG. 5) and/or any other desired processing circuitry and/or software on host device 102 (e.g., external to TPM 116).

As shown in FIG. 12, at time TD, host device 102 may attempt to access data on the encrypted portion(s) of storage 110 (e.g., after being powered on). OS 112 may transmit its encrypted storage key 221′ and fingerprint 202 to server 100 (e.g., server client 98 of FIG. 5). In response to receiving encrypted storage key 221′ and fingerprint 202, server 100 may retrieve and verify the identity of host device 102 using the received fingerprint 202 (at operation 224). If desired, server 100 may compare the identity of host device 102 (e.g., as identified based on fingerprint 202) to the list of revoked hosts 97 (FIG. 5). If/when server 100 determines that the identity of host device 102 is included on the list of revoked hosts 97, server 100 may discard the encrypted storage key and the fingerprint and may forego the remaining operations of FIG. 12 (e.g., processing may proceed to operation 186 of FIG. 8). If/when server 100 determines that the identity of host device 102 is not included on the list of revoked hosts 97, processing may proceed to operation 240.

At operation 240, server 100 may generate a deterministic key pair that is unique to host device 102 based on fingerprint 202. This may include, for example, generating hash output 208 using fingerprint 202, entropy source(s) 204, and hashing function 206, and then inputting hash output 208 to deterministic key generator 210 (FIG. 10). The deterministic key pair may include exchange key 212, which is unique to host device 102.

At operation 242, server 100 may decrypt (unwrap) encrypted storage key 221′ using the generated exchange key 212. This may recover the unencrypted storage key 221 generated by OS 112 at operation 220 of FIG. 11, even though host device 102 never transmitted the unencrypted storage key to server 100. Because server 100 is in trusted environment 90 (FIG. 5), the unencrypted storage key 221 remains secure even if it is stored at server 100 for a prolonged period of time.

At time TE, server 100 may transmit its generated unencrypted storage key 221 to OS 112. In response to receiving the unencrypted storage key 221 from server 100, OS 112 may decrypt the encrypted portion(s) of storage 110 using the unencrypted storage key 221 received from server 100, effectively unlocking storage 110 for subsequent access by OS 112. Server 100 may then discard the unencrypted storage key 221 used to unencrypt storage 110 and processing may proceed to operation 192 of FIG. 8. In this way, data stored on storage 110 of host device 102 may remain encrypted and secure even when host device 102 is powered off or unable to reach server 100, and server 100 may grant host device 102 the ability to encrypt and decrypt its storage 110 only upon verification of the identity of host device 102 and upon verification that host device 102 has not been revoked from receiving services from server 100. In addition, enumeration or brute force is not a viable option for accessing the encrypted portion(s) of storage 110, because there are as many as 2²⁵⁶ possible host device fingerprints that would need to be checked while attempting to unlock storage 110 (e.g., depending on the size of the fingerprint). If desired, host device 102 and/or server 100 may impose a rate limit on requests by host device 102 to decrypt storage 110, which makes it even more infeasible to decrypt storage 110 via brute force.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

One or more elements described herein (e.g., UE devices 10, satellite 12, gateway 14, CN 20, etc.) may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The methods and operations described above in connection with FIGS. 1-12 may be performed using software, firmware, and/or hardware (e.g., dedicated circuitry or hardware). Software code for performing these operations may be stored on non-transitory computer readable storage media (e.g., tangible computer readable storage media) stored on one or more of the components of communications system 38 (e.g., storage circuitry 46 of FIG. 2 or similar storage circuitry on satellites 12, gateways 14, CN 20, network portion 18, etc.). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of communications system 38 (e.g., processing circuitry 48 of FIG. 2 or similar processing circuitry on satellites 12, gateways 14, CN 20, network portion 18, etc.). The processing circuitry may include microprocessors, central processing units (CPUs), application-specific integrated circuits with processing circuitry, or other processing circuitry.

For one or more aspects, at least one of the components set forth in one or more of the preceding figures may be configured to perform one or more operations, techniques, processes, or methods as set forth herein. For example, the control circuitry as described above in connection with one or more of the preceding figures may be configured to operate in accordance with one or more of the examples set forth herein. For another example, circuitry associated with a UE, satellite, gateway, core network, base station, network element, etc. as described above in connection with one or more of the preceding figures may be configured to operate in accordance with one or more of the examples set forth herein.

An apparatus (e.g., an electronic user equipment device, a wireless base station, etc.) may be provided that includes means to perform one or more elements of a method described in or related to any of the methods or processes described herein.

One or more non-transitory computer-readable media comprising instructions to cause an electronic device, upon execution of the instructions by one or more processors of the electronic device, to perform one or more elements of any method or process described herein.

An apparatus comprising logic, modules, or circuitry to perform one or more elements of a method described in or related to any of the method or process described herein.

An apparatus comprising: one or more processors and one or more non-transitory computer-readable storage media comprising instructions that, when executed by the one or more processors, cause the one or more processors to perform the method, techniques, or process as described herein.

A signal, datagram, information element, packet, frame, segment, PDU, or message or datagram may be provided as described in or related to any of the examples described herein.

A signal encoded with data, a datagram, IE, packet, frame, segment, PDU, or message may be provided as described in or related to any of the examples described herein.

An electromagnetic signal may be provided carrying computer-readable instructions, wherein execution of the computer-readable instructions by one or more processors is to cause the one or more processors to perform the method, techniques, or process as described in or related to any of the examples described herein.

A computer program comprising instructions, wherein execution of the program by a processing element is to cause the processing element to carry out the method, techniques, or process as described in or related to any of the examples described herein.

A signal in a wireless network as shown and described herein may be provided.

A method of communicating in a wireless network as shown and described herein may be provided.

A system for providing wireless communication as shown and described herein may be provided.

A device for providing wireless communication as shown and described herein may be provided.

Any of the above-described examples may be combined with any other example (or combination of examples), unless explicitly stated otherwise. The foregoing description of one or more implementations provides illustration and description but is not intended to be exhaustive or to limit the scope of aspects to the precise form disclosed.

The foregoing is merely illustrative and various modifications can be made to the described embodiments. The foregoing embodiments may be implemented individually or in any combination.

What is claimed is:

1. A method of operating a server, comprising:
receiving, via a communications interface with a host device, a challenge request that includes a cryptographic key stored at the host device;
attempting to verify, using processing circuitry, an identity of the host device based on the challenge request;
encrypting, using the processing circuitry, a secret based on the cryptographic key responsive to verifying the identity of the host device;
transmitting, via the communications interface with the host device, a challenge that includes the encrypted secret;
receiving, via the communications interface with the host device, a request that includes the secret;
attempting to verify, using the processing circuitry, a hardware state of the host device based on the request; and
transmitting, via the communications interface with the host device, a data payload responsive to verifying the hardware state of the host device.

2. The method of claim 1, wherein the cryptographic key comprises a public endorsement key, the challenge request comprises an endorsement key certificate associated with the public endorsement key and stored at the host device, and attempting to verify the identity of the host device comprises attempting to verify the identity of the host based on the endorsement key certificate.

3. The method of claim 2, wherein the challenge request further comprises:
a public attestation key generated by the host device based on the public endorsement key.

4. The method of claim 3, wherein the challenge comprises an encrypted credential associated with the encrypted secret.

5. The method of claim 4, wherein the challenge further comprises a platform configuration register (PCR) nonce.

6. The method of claim 5, wherein the request comprises PCR information and wherein attempting to verify the hardware state of the host device comprises attempting to verify the hardware state of the host device based on the PCR information.

7. The method of claim 6, wherein the PCR information comprises a PCR quote, a PCR digest, or a PCR event log.

8. The method of claim 1, wherein the request identifies a corresponding action, the action comprises a provisioning action, a bootstrapping action, or a renew action, and the data payload is associated with the action identified by the request.

9. A method of operating an electronic device, comprising:
transmitting, via a communications interface with a server, a challenge request that includes a public endorsement key and an endorsement key certificate stored on a trusted platform module (TPM) in the electronic device;
receiving, via the communications interface with the server, a challenge that includes an encrypted secret generated by the server based on the public endorsement key;
decrypting, at the TPM, the encrypted secret to produce a decrypted secret; and
transmitting, via the communications interface with the server, a request for a data payload, wherein the request for the data payload includes the decrypted secret.

10. The method of claim 9, wherein the electronic device comprises storage that is separate from the TPM, the storage stores a client binary, the client binary transmits the challenge request via the communications interface with the server, the client binary receives the challenge via the communications interface with the server, the client binary transmits the request for the data payload via the communications interface with the server, and the client binary receives the decrypted secret from the TPM.

11. The method of claim 10, further comprising:
receiving, at the client binary, a public attestation key and attestation data from the TPM, wherein the TPM generates the public attestation key based on the public endorsement key and wherein the challenge request includes the attestation data and the public attestation key.

12. The method of claim 10, wherein the challenge comprises a platform configuration register (PCR) nonce and the method further comprises:
transmitting, using the client binary, the PCR nonce to the TPM.

13. The method of claim 12, further comprising:
receiving, at the client binary, PCR information produced by the TPM based on the PCR nonce, wherein the request for the data payload includes the PCR information.

14. The method of claim 13, wherein the PCR information comprises a PCR quote, a PCR digest, or a PCR event log.

15. The method of claim 10, wherein the request for the data payload identifies an action associated with the data payload and wherein the action comprises a provisioning action, a bootstrap action, or a renew action, the method further comprising:
receiving, via the communications interface with the server, the data payload after transmitting the request for the data payload; and
installing the data payload on the storage.

16. A method of operating an electronic device, comprising:
generating, using software stored on storage, a cryptographic fingerprint associated with the electronic device based on an endorsement certificate that is stored on a trusted platform module (TPM) separate from the storage;
transmitting, via a communications interface with a server, the cryptographic fingerprint;
receiving, via the communications interface with the server, a first cryptographic key generated by the server based on the cryptographic fingerprint;
encrypting the storage using a second cryptographic key;
encrypting the second cryptographic key using the first cryptographic key; and
storing the encrypted second cryptographic key on the encrypted storage.

17. The method of claim 16, further comprising:
transmitting, via the communications interface with the server, the encrypted second cryptographic key;
receiving, via the communications interface with the server, the second cryptographic key; and
decrypting the storage using the second cryptographic key received via the communications interface with the server.

18. The method of claim 16, further comprising:
deleting the second cryptographic key after encrypting the storage.

19. The method of claim 16, wherein generating the cryptographic fingerprint comprises inputting the endorsement certificate to a hashing function.

20. The method of claim 16, further comprising:
powering down the electronic device after encrypting the storage; and
powering on the electronic device after powering down the electronic device and prior to transmitting the encrypted second cryptographic key, wherein the storage remains encrypted between powering down and powering on the electronic device.
